(19) United States
(12) Patent Application Publication
(10) Pub. No.: US 2012/0169783 A1
(43) Pub. Date: Jul. 5, 2012

(54) DISPLAY DRIVING CIRCUIT AND OPERATING METHODS

(75) Inventor: Hyun-sang Park, Seongnam-si (KR)

(73) Assignee: SAMSUNG ELECTRONICS CO., LTD., Suwon-si (KR)

(21) Appl. No.: 13/292,360

(22) Filed: Nov. 9, 2011

(30) Foreign Application Priority Data
Jan. 4, 2011 (KR) 10-2011-0000549

(51) Int. Cl. G09G 5/10

(52) U.S. Cl. 345/690

(57) ABSTRACT

A display driving circuit includes a buffer unit receiving gradation voltages and generating data signals that drive a panel. A first buffer unit includes “M” main buffers corresponding to M data lines of the panel and a second buffer unit comprises “N” sub buffers, N being less than M. A first switch unit controls a transmission path along which the gradation voltages are applied to the buffer unit, and a second switch unit controls a transmission path along which the data signals are supplied to the data lines. Switches in the second switch unit are turned ON during charge sharing.

### CROSS-REFERENCE TO RELATED APPLICATIONS

This application claims the benefit of Korean Patent Application No. 10-2011-0000549 filed on Jan. 4, 2011, the subject matter of which is hereby incorporated by reference.

### BACKGROUND

The inventive concept relates to display driving circuits and methods of driving displays using such circuits. More particularly, the inventive concept relates to display driving circuits that perform polarity inversion driving, display devices including such display driving circuits, and method of operating such display driving circuits.

Certain displays, such as flat panel displays, have been widely adopted in consumer electronic devices, such as computers, mobile handsets, and monitors. Liquid crystal displays (LCD) are one type of flat panel display. Within LCDs, for example, a plurality of pixels are arranged across the image surface of the panel. When pixels in the plurality of pixels are selectively driven by data signals supplied by a specialized integrated circuit called a display driver, an image is displayed on the panel.

In order to prevent degradation of the pixels over the lifetime of the display device, so-called polarity inversion driving methods have been used. Such driving methods frequently invert the polarity of drive signals applied to the pixels. Polarity inversion driving methods may be classified as a frame inversion methods that perform polarity inversion on a frame by frame basis, line inversion methods that perform polarity inversion on a lime by line basis, and dot inversion methods that perform polarity inversion on a pixel (or a small grouping of pixels) basis.

In order to perform polarity inversion driving method, buffers outputting a data signal with positive polarity, buffers outputting a data signal with negative polarity, and a plurality of switches switching output signals from the buffers will usually be disposed in a display driving circuit. Also, when the polarity inversion driving method is performed, charge sharing is commonly used to temporarily share charge apparent on output lines of the buffers in order to reduce power consumption and improve image visibility. To better facilitate charge sharing, switches are further disposed in the display driving circuit, thereby increasing manufacturing costs of the display driving circuit and also increasing the die area occupied by the display driving circuit.

### SUMMARY

Certain embodiments of the inventive concept provide a display driving circuit and related methods of operation that require relatively fewer switches for constituent switching units. Therefore, the display driving circuit is less expensive to manufacture and occupies a smaller die area.

In one embodiment, the inventive concept provides a display driving circuit comprising; a buffer unit that receives gradation voltages and generates data signals that drive a panel, the buffer unit comprising a first buffer unit and a second buffer unit, wherein the first buffer unit comprises M main buffers corresponding to M data lines of the panel and the second buffer unit comprises N sub buffers, a first switch unit that controls a transmission path along which the gradation voltages are applied to the buffer unit, and a second switch unit comprising switches that control a transmission path along which the data signals are supplied to the data lines, wherein the switches are turned ON when charge sharing is performed, “M” being a positive integer, and “N” being a positive integer less than M.

In another embodiment, the inventive concept provides a display driving circuit comprising; a buffer unit that receives gradation voltages and generates data signals that drive a panel, the buffer unit comprising (M+N) buffers corresponding to M data lines, a first switch unit that controls a transmission path along which the gradation voltages are applied to the buffer unit, and a second switch unit that controls a transmission path along which the data signals are supplied to the M data lines, wherein the first and second switch units are configured in a first connection state to output from M buffers belonging to a first group from among the (M+N) buffers, and are further configured in a second connection state to outputs of M buffers belonging to a second group from among the (M+N) buffers.

In another embodiment, the inventive concept provides a source driver for driving data lines of a panel, the source driver comprising; a buffer unit that receives gradation voltages and generating data signals that drive a panel, the buffer unit comprising a first buffer unit and a second buffer unit, wherein the first buffer unit comprises M main buffers corresponding to M data lines of the panel and the second buffer unit comprises N sub buffers, a first switch unit that controls a transmission path along which the gradation voltages are applied to the buffer unit, and a second switch unit comprising switches that control a transmission path along which the data signals are supplied to the data lines, wherein the switches are turned ON when charge sharing is performed.

In another embodiment, the inventive concept provides a display device comprising; a panel that displays an image; and a driving circuit that drives the panel, wherein the driving circuit comprises a source driver that drives data lines of the panel, the source driver comprising; a buffer unit that receives gradation voltages and generating data signals that drive a panel, the buffer unit comprising a first buffer unit and a second buffer unit, wherein the first buffer unit comprises M main buffers corresponding to M data lines of the panel and the second buffer unit comprises N sub buffers, a first switch unit that controls a transmission path along which the gradation voltages are applied to the buffer unit, and a second switch unit comprising switches that control a transmission path along which the data signals are supplied to the data lines, wherein the switches are turned ON when charge sharing is performed.

In another embodiment, the inventive concept provides a method of operating a display driving circuit driving a panel, wherein the display driving circuit comprises a first buffer unit with M main buffers corresponding to M data lines and a second buffer unit with N sub buffers, the method comprising; generating data signals using the first and second buffer units, controlling a transmission path along which gradation voltages are applied to the first and second buffer units by selectively switching switches in a first switch unit, controlling a transmission path along which the data signals are supplied to the M data lines by selectively switching switches in the second switch unit, and electrically connecting the M data lines suing switches in the second switch unit to perform charge sharing.

### BRIEF DESCRIPTION OF THE DRAWINGS

Exemplary embodiments of the inventive concept will be more clearly understood from the following detailed description taken in conjunction with the accompanying drawings in which:

FIG. 1 is a block diagram of a display device according to an embodiment of the inventive concept;

FIG. 2 is a block diagram of a source driver illustrated in FIG. 1, according to an embodiment of the inventive concept;

FIG. 3 illustrates methods of driving a panel based on one of various dot inversion methods;

FIG. 4 is a detailed block diagram of the source driver of FIG. 1, according to an embodiment of the inventive concept;

FIGS. 5A and 5B are detailed block diagrams of operations of a first switch unit and a second switch unit included in the source driver of FIG. 4, according to an embodiment of the inventive concept;

FIGS. 6A and 6B are circuit diagrams of the first and second switch units of FIG. 4, according to embodiments of the inventive concept;

FIG. 7 is a circuit diagram illustrating a connection state of the second switch unit to perform charge sharing, according to an embodiment of the inventive concept;

FIG. 8 is a circuit diagram of a buffer included in a buffer unit, according to an embodiment of the inventive concept;

FIG. 9 is a timing diagram of signals related to the connection states of FIGS. 6A, 6B, and 7, according to an embodiment of the inventive concept;

FIG. 10 illustrates a block diagram and a circuit diagram of a buffer included in a buffer unit, according to another embodiment of the inventive concept;

FIGS. 11A and 11B are layout diagrams of the source driver of FIG. 1, according to another embodiment of the inventive concept;

FIGS. 12A and 12B are block diagrams of a source driver according to another embodiment of the inventive concept;

FIGS. 13A and 13B are block diagrams of a source driver according to another embodiment of the inventive concept;

FIGS. 14A to 16 are block diagrams of a source driver according to another embodiment of the inventive concept;

FIG. 17 is a timing diagram of signals used to operate the source driver illustrated in FIGS. 14A to 16, according to an embodiment of the inventive concept;

FIGS. 18A and 18B are block diagrams of a source driver according to another embodiment of the inventive concept; and

FIGS. 19 and 20 are flowcharts illustrating a method of operating a display driving circuit, according to an embodiment of the inventive concept.

### DETAILED DESCRIPTION OF EMBODIMENTS

Certain embodiments of the inventive concept will now be described in some additional detail with reference to the accompanying drawings. However, the inventive concept may be variously embodied and should not be construed as being limited to only the illustrated embodiments. Throughout the written description and drawings, like reference numbers and labels are used to denote like or similar elements.

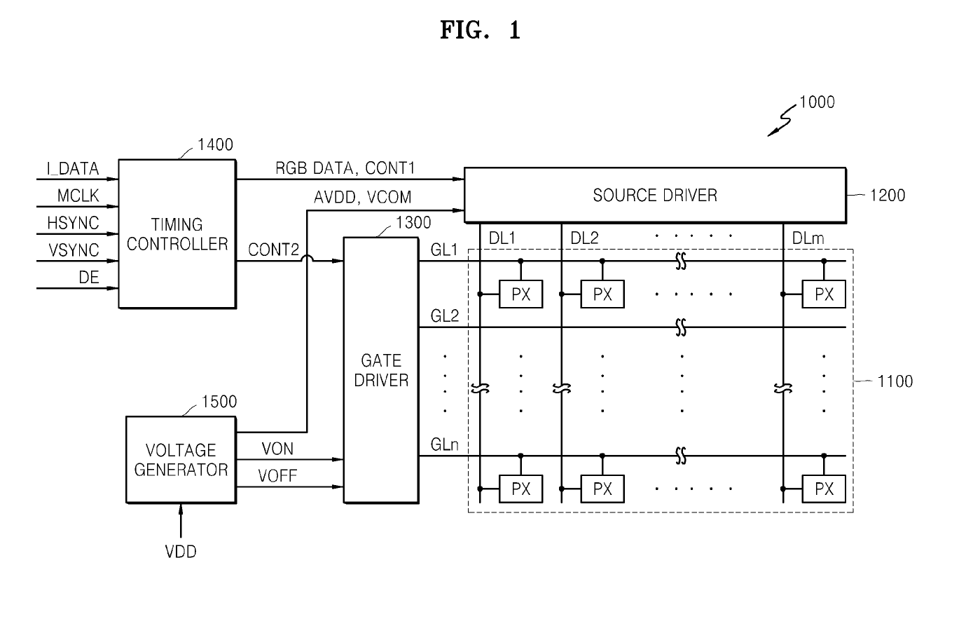

FIG. 1 is a block diagram of a display device 1000 according to an embodiment of the inventive concept. Referring to FIG. 1, the display device 1000 generally comprises; a panel 1100 that displays an image, and a driving circuit that drives the panel 1100.

The driving circuit may include a source driver 1200 that drives a plurality of data lines DL1 to DLm of the panel 1100, a gate driver 1300 that drives a plurality of gate lines GL1 to GLn of the panel 1100, a timing controller 1400 that generates various timing signals or data RGB DATA, and control signals CONT1 and CONT2 controlling the source driver 1200 and the gate driver 1300, and a voltage generator 1500 that generates various voltages VON, VOFF, AVDD, and VCOM that may be used to drive the display device 1000.

Any type of display, including for example a flat panel display, may be used as the display device 1000. Flat panel displays include but are not limited to such conventionally understood devices as the liquid crystal display (LCD), organic electro luminance (EL) display, and plasma display panel (PDP). For purposes of clarity, the following description assumes that the display device 1000 is an LCD.

The panel 1100 includes the gate lines GL1 to GLn, the data lines DL1 to DLm that intersect the gate lines GL1 to GLn, and a plurality of pixels PX disposed at respective intersections of the gate lines GL1 to GLn and data lines DL1 to DLm. Although not shown, if the display device 1000 is assumed to be a thin film transistor (TFT) LCD, then each of the pixels PX includes a TFT, the gate electrode and the source electrode of which are respectively connected to one of the data lines DL1 to DLm and one of the gate lines GL1 to GLn, and a liquid crystal capacitor and a storage capacitor that are connected to a drain electrode of the TFT. In such a pixel structure, when a gate line is selected, the TFT of a pixel connected to the selected gate line is turned ON, and then a data signal indicating pixel information is supplied to the data lines DL1 to DLm from the source driver 1200. The data signal is supplied to the liquid crystal capacitor and the storage capacitor of the connected pixel via the TFT of the connected pixel, and the liquid crystal capacitor and the storage capacitor are then driven to display an image.

The timing controller 1400 receives external data I_DATA, a horizontal synchronization signal H_SYNC, a vertical synchronization signal V_SYNC, a clock signal MCLK, and a data enable signal DE from an external device (not shown). The timing controller 1400 generates pixel data RGB DATA, the format of which is according to interface specifications with the source driver 1200, and supplies the pixel data RGB DATA to the source driver 1200. Also, the timing controller 1400 generates various control signals that control the operative timing between the source driver 1200 and the gate driver 1300, outputs at least one first control signal CONT1 to the source driver 1200, and outputs at least one second control signal CONT2 to the gate driver 1300. The voltage generator 1500 receives an externally supplied power supply voltage VDD, and generates various voltages necessary to the operation of the display device 1000. For example, the voltage generator 1500 may be used to generate a gate ON voltage VON and a gate OFF voltage VOFF. The gate ON voltage VON and the gate OFF voltage VOFF may then be applied to the gate driver 1300 to generate an analog power supply voltage AVDD and a common voltage VCOM and applies the analog power supply voltage AVDD and the common voltage VCOM to the source driver 1200.

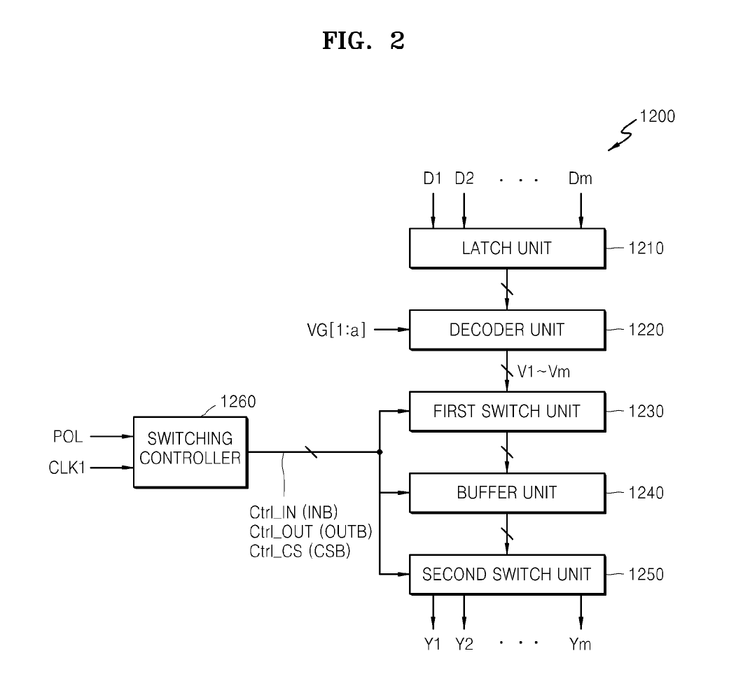

FIG. 2 is a block diagram further illustrating in one possible embodiment the source driver 1200 of FIG. 1.

Referring to FIGS. 1 and 2, the source driver 1200 comprises; a latch unit 1210, a decoder unit 1220, a first switch unit 1230, a buffer unit 1240, and a second switch unit 1250. The source driver 1200 may further comprise a switching controller 1260 that generates various switching control signals for controlling switching operations of the first and second switch units 1230 and 1250.

The source driver 1200 includes “M” channels corresponding to the M data lines DL1 to DLm, and output M data signals Y1 to Ym driving the panel 1100 via the M channels. The M data signals Y1 to Ym are provided to drive pixels corresponding to one gate line of the panel 1100. A frame is displayed on the panel 1100 by respectively outputting the M data signals Y1 to Ym for the N gate lines GL1-GLn.

The latch unit 1210 receives and latches pixel data D1 to Dm used to drive the panel 1100. The pixel data D1 to Dm may be the pixel data RGB DATA provided from the timing controller 1400 of FIG. 1. The latch unit 1210 receives and stores the pixel data D1 to Dm, and outputs the stored pixel data D1 to Dm in parallel with the decoder unit 1220.

The decoder unit 1220 decodes the pixel data D1 to Dm, which are digital signals, to analog voltages. The decoder unit 1220 includes a plurality of decoders (not shown), the total number of which is equal to the number of the M channels of the source driver 1200. One of the pixel data D1 to Dm and a plurality of gradation voltages VG[1:a] are provided to each of the plurality of decoders. Each of the decoders decodes the received pixel data, and selects and outputs one of the plurality of gradation voltages VG[1:a] based on a result of the decoding. For example, if each of the pixel data D1 to Dm consists of K bits and the plurality of gradation voltages VG[1:a] includes 2^{k} gradation voltages, then each of the decoders decodes one of the pixel data D1 to Dm each consisting of K bits, and selects and outputs one of the plurality of gradation voltages VG[1:a] based on a result of the decoding. The source driver 1200 may include a gradation voltage generator (not shown) that generates the plurality of gradation voltages VG[1:a]. Hereinafter, voltages generated by the gradation voltage generator will be referred to as “reference gradation voltages VG[1:a]”, and voltages selected by the decoder unit 1220 to respectively correspond to the M channels will be referred to as “gradation voltages V1 to Vm”.

The gradation voltages V1 to Vm output from the decoder unit 1220 are sequentially provided to the first switch unit 1230 and the buffer unit 1240, and finally, to the second switch unit 1250. Outputs of the second switch unit 1250 are provided as the data signals Y1 to Ym to the data lines DL1 to DLm of the panel 1100. The first switch unit 1230 includes a plurality of switches (not shown), and controls a transmission path along which the gradation voltages V1 to Vm are applied to the buffer unit 1240 according to the respective switching operations of the switches.

In one embodiment, the buffer unit 1240 includes a first buffer unit (not shown) including M main buffers corresponding to the M data lines DL1 to DLm, and a second buffer unit (not shown) including at least one sub buffer. However, if the second buffer unit includes N sub buffers, the first switch unit 1230 may receive the M gradation voltages V1 to Vm, and may perform switching with respect to and thereby apply the gradation voltages V1 to Vm to M buffers from among (M+N) buffers.

With this configuration, the buffer unit 1240 receives and buffers the gradation voltages V1 to Vm and generates the data signals Y1 to Ym used to drive the panel 1100. As noted above, the buffer unit 1240 may include a plurality of buffers, for example, the first buffer unit and the second buffer unit. The data signals Y1 to Ym output by the buffer unit 1240 in parallel are provided to the second switch unit 1250. The second switch unit 1250 performs respective switching operation to control transmission path(s) along which the data signals Y1 to Ym are provided to the data lines DL1 to DLm. In other words, the second switch unit 1250 controls the transmission path(s) along which the data signals Y1 to Ym are provided between the (M+N) buffers and the M data lines DL1 to DLm.

The switching controller 1260 may be used to generate control signals that control the different switching operations described above in response to an externally provided signal (e.g., signal(s) provided by the timing controller 1400 of FIG. 1). The control signals generated by the switching controller 1260 may be provided to the first and second switch units 1230 and 1250 and the buffer unit 1240. For example, in the illustrated embodiment of FIG. 2, the switching controller 1260 receive a polarity control signal POL and a clock signal CLK1. In response to the polarity control signal POL and the clock signal CLK1, the switching controller 1260 generates the switching control signals Ctrl_IN(INB), Ctrl_OUT(OUTB), and Ctrl_CS(CSB). The polarity control signal POL may be characterized by a pulse cycle related to polarity-driving for the panel 1100. For example, the polarity control signal POL may have a cycle corresponding to one scan unit or to one frame unit for the panel 1100.

Under the working assumption that the display device 1000 is an LCD, the panel 1100 may be driven according to a polarity inversion method to prevent degradation of the liquid crystal material within the LCD. In order to use the polarity inversion method according to certain embodiments of the inventive concept, the buffer unit 1240 may include positive buffers generating signals having a positive polarity and negative buffers generating signals having a negative polarity. Some of the M main buffers are positive buffers that receive gradation voltages and generate data signals having positive polarity, and the other main buffers are negative buffers that receive the gradation voltages and generate data signals having negative polarity. The N sub buffers may be used to generate data signals having the same or different polarities.

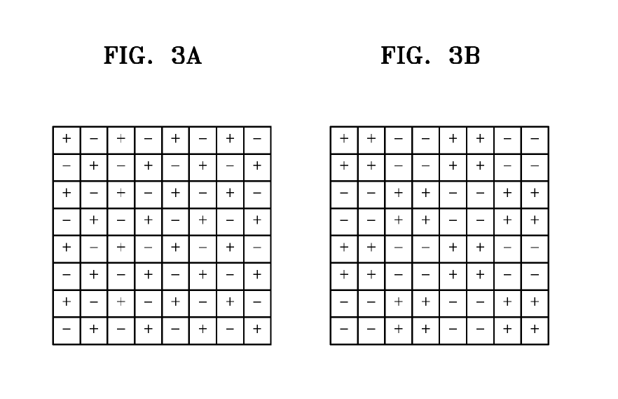

FIG. 3, including FIGS. 3A and 3B, conceptually illustrates certain methods of driving a panel based on one of various dot inversion methods. FIG. 3A illustrates a general dot inversion method for performing polarity inversion in pixel units, in which M pixels disposed on one gate line are driven by alternately supplying a positive (+) data signal and a negative (−) data signal. For example, pixels on a first gate line are driven by supplying a positive polarity data signal to odd-numbered data lines and supplying a negative polarity data signal to even-numbered data lines. Pixels on a second gate line are driven by supplying a negative polarity data signal to the odd-numbered data lines and supplying a positive polarity data signal to the even-numbered data lines.

FIG. 3B illustrates a H2 dot inversion method for driving a panel. In the H2 dot inversion method, M pixels disposed on one gate line are driven by alternately supplying a positive (+) data signal and a negative (−) data signal to every two pixels among the M pixels. For example, pixels on a first gate line are driven by supplying a positive polarity data signal to first and second data lines and supplying a negative polarity data signal to third and fourth data lines. In the H2 dot inversion method, the polarity of each channel may be changed for every two scan units. A panel may be also driven by the H2 dot inversion method by changing the polarity of each channel for every scan unit. The display device 1000 or the source driver 1200 of FIG. 1 according to certain embodiments of the inventive concept may polarity-drive the panel 1000 as illustrated in FIG. 3, and may also polarity-drive the panel 1100 according to other conventionally understood methods.

In order to use a polarity inversion method, the first buffer unit included in the buffer unit 1240 of FIG. 2 may include M/2 positive buffers and M/2 negative buffers. In the first buffer unit, the positive buffers and the negative buffers may be alternately arranged. In order to change the polarity of a signal supplied to the data lines DL1 to DLm, the first switch unit 1230 performs switching to apply a gradation voltage to either the positive buffers or the negative buffers.

When one of the dot inversion methods illustrated in FIG. 3 is used, the polarity of data signals supplied via each data line is changed in every scan cycle or in every two scan cycles. For example, if a positive polarity data signal is supplied to the first data line DL1 when the first gate line GL1 is selected, then a negative polarity data signal is supplied to the first data line DL1 when the second gate line GL2 is selected. In this case, before pixels on the second gate line GL2 are actually driven, charge sharing may be performed so that voltages of the data line DL1 to DLm charged with positive or negative electric charges may be approximately equal to a common voltage VCOM without having to drive the data line DL1 to DLm under control of the outside. In order to facilitate charge sharing, electric charge apparent on the data line DL1 to DLm may be shared by floating all output terminals of the source driver 1200 and connecting the data line DL1 to DLm with one another via an additional switch (not shown).

Display devices have been developed to be larger in size and have a higher resolution, and a frame frequency becomes higher to improve the image quality of moving pictures and to support three-dimensional (3D) images. Thus, signals output from various types of drivers need to have a high slew rate. For example, referring to FIG. 2, the source driver 1200 outputs the data signals Y1 to Ym via the M channels, and resistance values of switches at the output terminals of the source driver 1200 should be reduced to increase the slew rates of the data signals Y1 to Ym. However, the sizes of the switches may be increased to reduce their inherent resistance, and thereby reduce the die area of the source driver 1200 or a display driving circuit including the source driver 1200 is limited. In particular, not only the switches actually switching the gradation voltages V1 to Vm or the data signals Y1 to Ym, but also the switches performing charge sharing need to be additionally included in the source driver 1200. The more switches included in the source driver 1200, the larger the die area of the source driver 1200 or the display driving circuit including the source driver 1200.

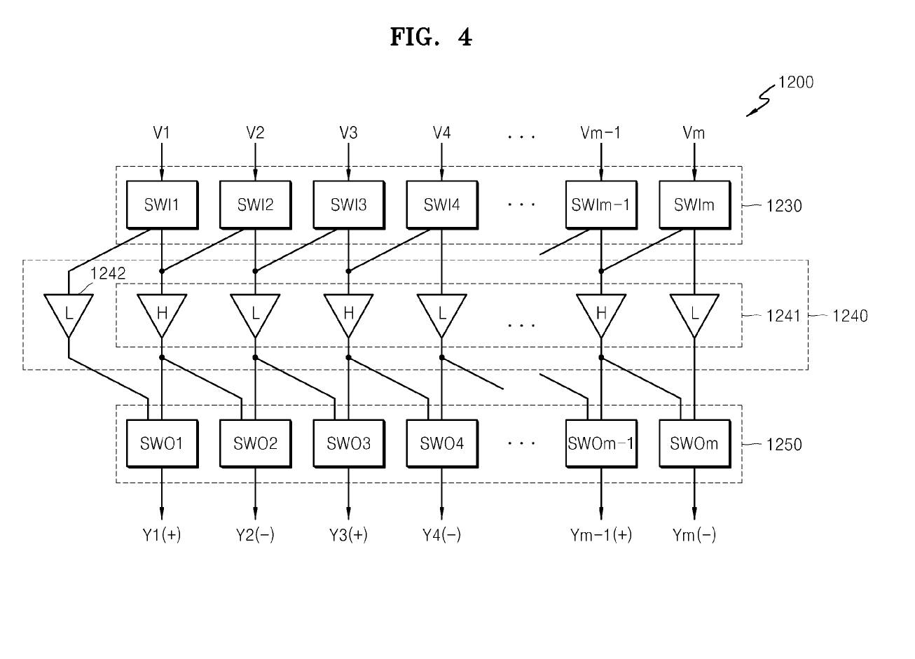

FIG. 4 is a block diagram further illustrating the source driver 1200 of FIG. 1 according to an embodiment of the inventive concept. The source driver 1200 FIG. 4 drives the panel 1100, for example, a liquid crystal panel, based on a polarity inversion method to prevent degradation of the liquid crystal panel, and requires only a small number of switches for performing polarity inversion driving and charge sharing, thereby improving the qualities of signals output via channels thereof and reducing the die area thereof. One possible approach to the operation of the source driver of FIG. 4 is described below.

Referring to FIG. 4, in the source driver 1200, the first switch unit 1230 includes M switch blocks SWI1 to SWIm corresponding to M gradation voltages V1 to Vm. Each of the M switch blocks SWI1 to SWIm includes at least one switch. The buffer unit 1240 includes a first buffer unit 1241 and a second buffer unit 1242. The first buffer unit 1241 includes M main buffers corresponding to M gradation voltages V1 to Vm. The M main buffers may include positive buffers generating positive polarity data signals and positive buffers generating negative polarity data signals and may be alternately arranged. The second buffer unit 1242 includes at least one sub buffer. FIG. 4 illustrates a case where one sub buffer is included in the second buffer unit 1242.

The second switch unit 1250 includes M switch blocks SWO1 to SWOm corresponding to the M data signals Y1 to Ym. Each of the M switch blocks SWO1 to SWOm includes at least one switch. The second switch unit 1250 receives the data signals Y1 to Ym from the buffer unit 1240, and supplies the data signals Y1 to Ym to the panel 1100 via the data lines DL1 to DLm.

If the M main buffers are disposed in parallel corresponding to the M channels of the source driver 1200, then opposing sides (e.g., arbitrarily oriented left side and right sides) of the M main buffers may be respectively referred to as a “first side” and a “second side”. The M switch blocks SWI1 to SWIm of the first switch unit 1230 disposed in relation to the M main buffers may be referred to as “1^{st} through Mth switch blocks”. The M switch blocks SWO1 to SWOm of the second switch unit 1250 may be referred to as “(M+1)th to 2Mth switch blocks”. The second buffer unit 1242 may be disposed on the first or second side of the first buffer unit 1241. For example, referring to FIG. 4, the second buffer unit 1242 may be disposed adjacent to a first main buffer to generate a positive polarity data signal. The second buffer unit 1242 includes a sub buffer for generating a data signal, e.g., a negative polarity data signal, the polarity of which is different from the polarity of the data signal generated by the first main buffer.

The switch blocks SWI1 to SWIm of the first switch unit 1230 receive the gradation voltages V1 to Vm and output the gradation voltages V1 to Vm to the buffer unit 1240. When the panel 1100 is driven according to the dot inversion method, the switch blocks SWI1 to SWIm alternately output the gradation voltages V1 to Vm to the positive buffers and the negative buffers. For example, the first switch block SWI1 applies the gradation voltage V1 to the positive buffer when an odd-numbered gate line is selected, and applies the gradation voltage V1 to the negative buffer when an even-numbered gate line is selected. Thus, switching is controlled in such a manner that the first and second switch units 1230 and 1250 have a first connection state or a second connection state in scan units.

Referring still to FIG. 4, M buffers belonging to a first group are selected from among (M+1) buffers in order to drive pixels on a gate line according to a first polarity type, and M buffers belonging to a second group are selected from among the (M+1) buffers to drive the pixels on the gate line according to a second polarity type. For example, when a first gate line is selected, the first switch unit 1230 has the first connection state, and the gradation voltages V1 to Vm are respectively applied to the buffers belonging to the first group, e.g., the M main buffers. In this case, the odd-numbered gradation voltages V1, V3, . . . through to Vm−1 are respectively applied to the positive buffers, and the even-numbered gradation voltages V2, V4, . . . through to Vm are respectively applied to the negative buffers. Then, when a second gate line is selected, the first switch unit 1230 has the second connection state and the gradation voltages V1 to Vm are respectively applied to the buffers belonging to the second group, e.g., the sub buffer 1242 and the first to (M−1)th main buffers SWI1 to SWIm−1. In this case, the odd-numbered gradation voltages V1, V3, . . . through to Vm−1 are respectively applied to the negative buffers, and the even-numbered gradation voltages V2, V4, . . . through to Vm are respectively applied to the positive buffers.

When the first gate line is selected, the second switch unit 1250 also has the first connection state. In this case, the data signals Y1 to Ym from the M main buffers SWI1 to SWIm are supplied to the data lines DL1 to DLm via the second switch unit 1250. Thus, the odd-numbered data signals Y1, Y3, . . . through to Ym−1 have positive polarities and are supplied to the odd-numbered data lines DL1, DL3, . . . through to DLm−1, and the even-numbered data signals Y2, Y4, . . . through to Ym have negative polarities and are supplied to the even-numbered data lines DL2, DL4, . . . through to DLm.

When the second gate line is selected, the second switch unit 1250 has the second connection state and the data signals Y1 to Ym from the sub buffer 1242 and the first to (M−1)th main buffers are supplied to the data line DL1 to DLm. In this case, the odd-numbered data signals Y1, Y3, . . . through to Ym−1 have negative polarities and are supplied to the odd-numbered data lines DL1, DL3, . . . through to DLm−1, and the even-numbered data signals Y2, Y4, . . . through to Ym have positive polarities and are supplied to the even-numbered data lines DL2, DL4, . . . through to DLm.

Pixels on N gate lines corresponding to one frame may be driven as described above. In the case of a subsequent frame, the panel 1100 may be driven using data signals, the polarities of which are different from those of the data signals used in the case of the previous frame. For example, if in the previous frame, the first gate line is driven in such a manner that the odd-numbered data signals Y1, Y3, . . . through to Ym−1 have positive polarities and the even-numbered data signals Y2, Y4, . . . through to Ym have negative polarities, then in a subsequent frame, the first gate line may be driven in such a manner that the odd-numbered data signals Y1, Y3, . . . through to Ym−1 have negative polarities and the even-numbered data signals Y2, Y4, . . . through to Ym have positive polarities.

In the first and second switch units 1230 and 1240 illustrated in FIG. 4, each positive buffer and each negative buffer do not form a pair of buffers and two data lines are not individually driven using each pair of buffers, but a buffer corresponding to one channel and another buffer disposed at a first side of the buffer are used to drive data line of the channel. To this end, the second buffer unit 1242 including at least one sub buffer is further disposed at the first side of the first buffer unit 1241 to form a transmission path along which the data signals Y1 to Ym are transmitted, by using the main buffers and the at least one sub buffer.

If the first switch unit 1230 has the first connection state, the first switch unit 1230 respectively applies the gradation voltages V1 to Vm to the first through Mth main buffers corresponding thereto. If the first switch unit 1230 has the second connection state, the first switch unit 1230 respectively applies the gradation voltages V1 to Vm to a main buffer or a sub buffer disposed at the first side. For example, the first gradation voltage V1 is applied to the first main buffer (positive buffer) when the first switch unit 1230 has the first connection state, and is applied to a sub buffer (negative buffer) at the first side of the first main buffer when the first switch unit 1230 has the second connection state. The third gradation voltage V3 is applied to a third main buffer (positive buffer) when the first switch unit 1230 has the first connection state, and is applied to one of at least one buffer (negative buffer) at the first side of the third main buffer when the first switch unit 1230 has the second connection state. FIG. 4 illustrates how a third gradation voltage V3 may be applied to a second main buffer (negative buffer) adjacent to the first side of the third main buffer.

To generalize from the above description, a Kth gradation voltage is applied to a corresponding Kth main buffer when the first and second switch units 1230 and 1250 have the first connection state, and is applied to a buffer from among the sub buffer and the first to (K−1)th main buffers when the first and second switch units 1230 and 1250 have the second connection state. Here, the variable “K” denotes a positive integer greater than the variable “M” is a positive integer. In other words, the Kth main buffer transmits a data signal to either the corresponding Kth data line or a data line disposed at the second side of the Kth data line, e.g., a data line from among the (K+1)th through Mth data lines. Such a mechanism exhibits one-directional characteristics. The outputs of the first switch unit 1230 are connected to the buffer unit 1240 using one-directional connection toward the first side, and the outputs of the buffer unit 1240 are connected to the second switch unit 1250 using one-directional connection toward the second side.

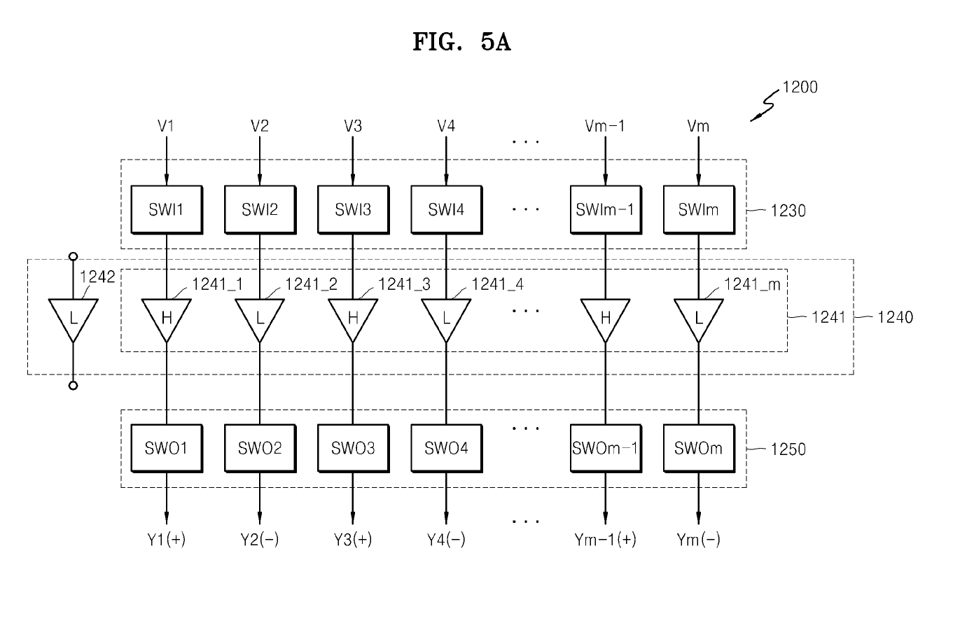

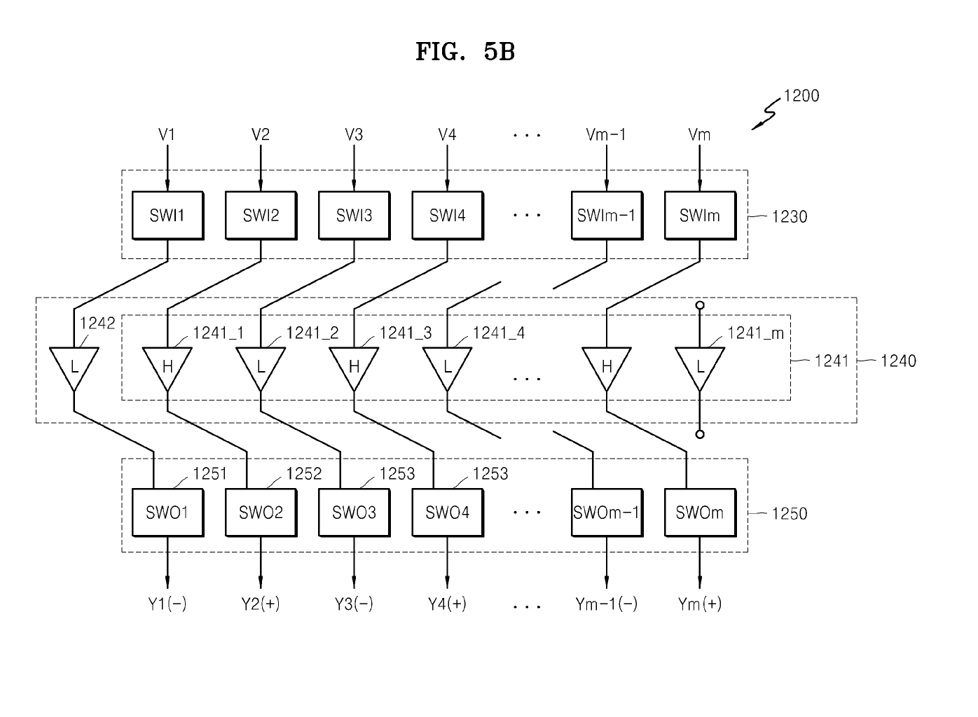

FIGS. 5A and 5B are block diagrams further illustrating one possible operation for the first switch unit 1230 and the second switch unit 1250 included in the source driver 1200 of FIG. 4 according to embodiments of the inventive concept. FIG. 5A illustrates a first connection state for the first and second switch units 1230 and 1250, and FIG. 5B illustrates a second connection state for the first and second switch units 1230 and 1250. Operation of a source driver according to an embodiment of the inventive concept is described below with reference to FIGS. 1, 5A, and 5B.

A connection state for each of the first and second switch units 1230 and 1250 is changed for scan units. For example, the first and second switch units 1230 and 1250 have the first connection state when a first gate line GL1 is selected, and have the second connection state when a second gate line GL2 is selected. When the first and second switch units 1230 and 1250 have the first connection state, the first to Mth switch blocks SWI1 to SWIm of the first switch unit 1230 respectively output the gradation voltages V1 to Vm to the first to Mth main buffers 1241_1 to 1241_{—}m. Also, the (M+1)th to 2Mth switch blocks SWO1 to SWOm of the second switch unit 1250 receive the data signals Y1 to Ym from the first to Mth main buffers 1241_1 to 1241_{—}m and output the data signals Y1 to Ym to the data lines DL1 to DLm, respectively. Thus, the odd-numbered data signals Y1, Y3, . . . have positive polarities and the even-numbered data signals Y2, Y4, . . . have negative polarities.

When the first and second switch units 1230 and 1250 have the second connection state, the first to Mth switch blocks SWI1 to SWIm of the first switch unit 1230 respectively output the gradation voltages V1 to Vm to the sub buffer 1242 and the first to (M−1)th main buffers 1241_1 to 1241_{—}m−1. For example, the first switch block SWI1 outputs the first gradation voltage V1 to the sub buffer 1242, and the second switch block SWI2 outputs the second gradation voltage V2 to the first main buffer 1241_1.

The (M+1)th to 2Mth switch blocks SWO1 to SWOm of the second switch unit 1250 are respectively connected to output terminals of the sub buffer 1242 and the first to (M−1)th main buffers 1241_1 to 1241_{—}m−1. The data signal Y1 output from the sub buffer 1242 is supplied to the first data line DL1 via the (M+1)th switch block SWO1. The data signals Y2 to Ym output from the first to (M−1)th main buffers 1241_1 to 1241_{—}m−1 are respectively supplied to the second to Mth data lines DL2 to DLm via the (M+2)th to 2Mth switch blocks SWO2 to SWOm. Thus, the odd-numbered data signals Y1, Y3, . . . have negative polarities, and the even-numbered data signals Y2, Y4, . . . have positive polarities.

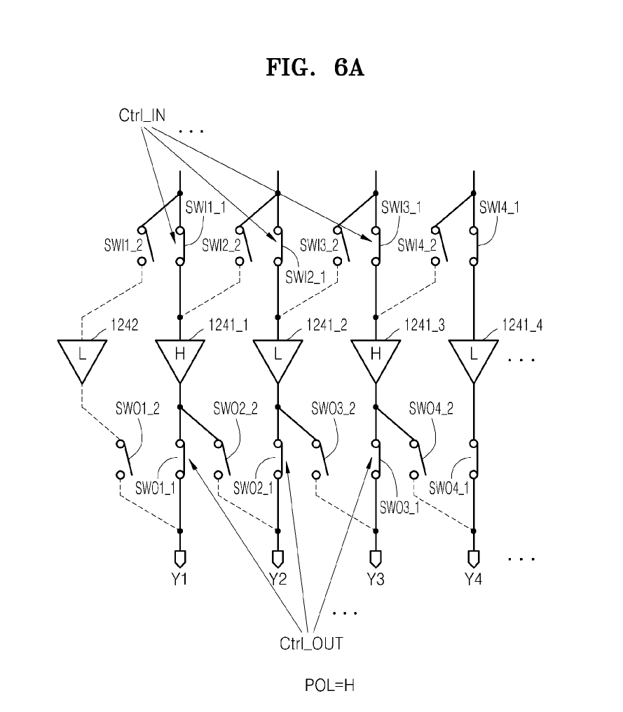

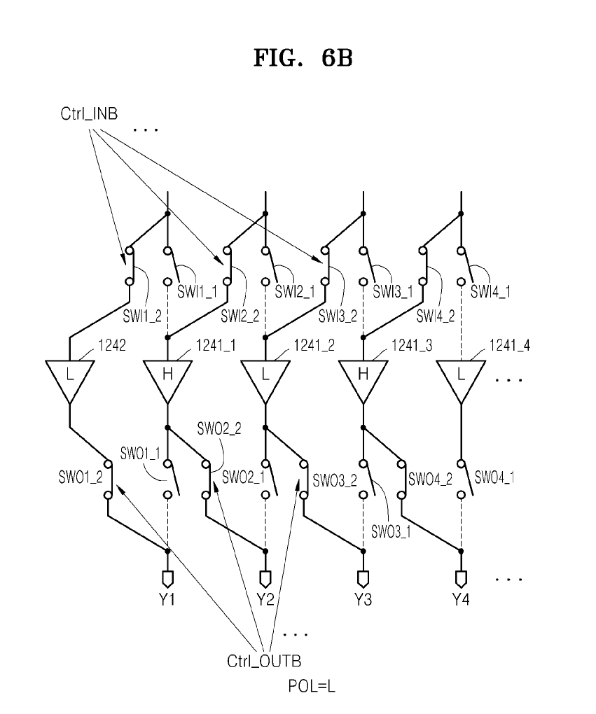

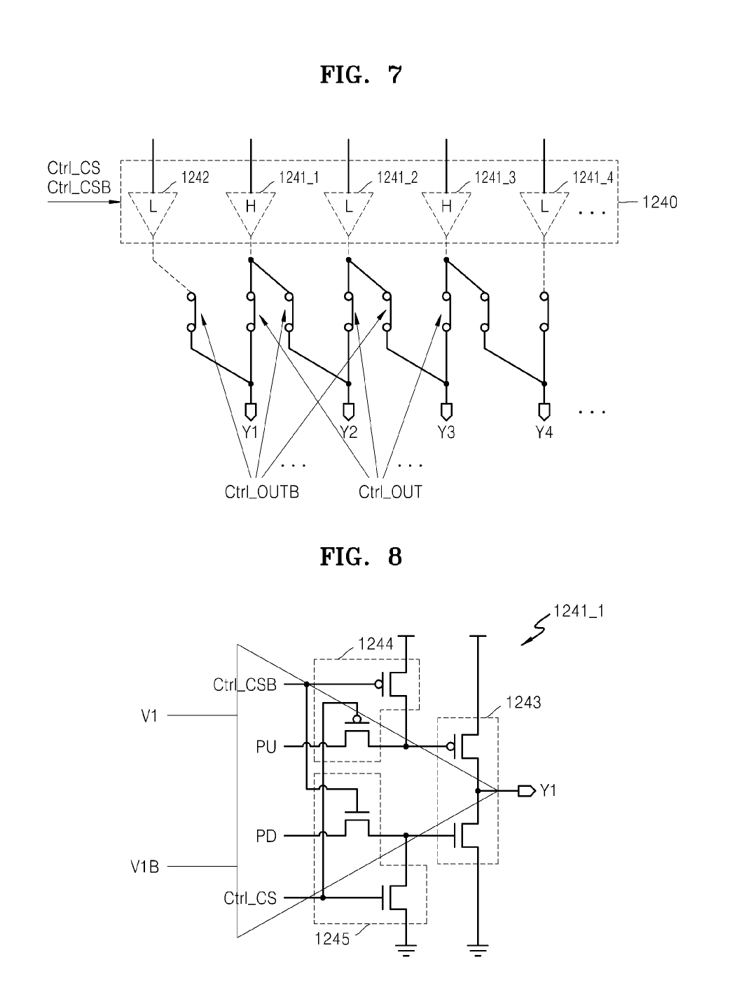

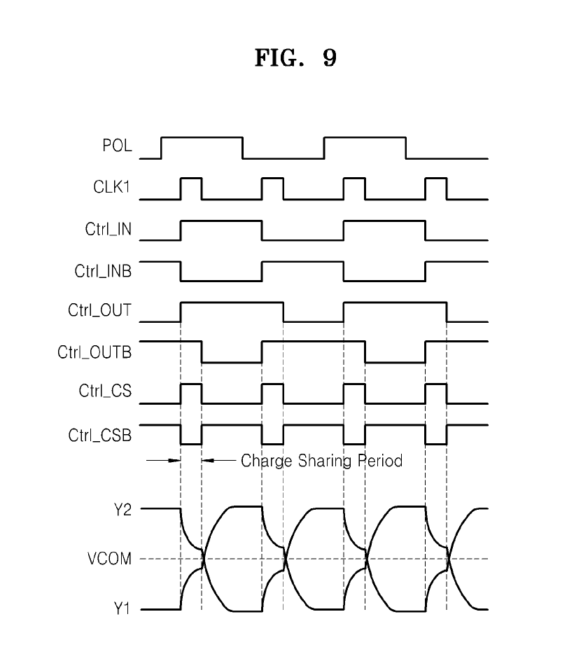

FIGS. 6A and 6B are circuit diagrams of the first and second switch units 1230 and 1250 of FIG. 4 according to embodiments of the inventive concept. FIG. 7 is a circuit diagram illustrating a connection state for the second switch unit 1230 to perform charge sharing according to an embodiment of the inventive concept. FIG. 8 is a circuit diagram of a buffer included in a buffer unit according to an embodiment of the inventive concept. FIG. 9 is a timing diagram illustrating signals related to the connection states shown in FIGS. 6A, 6B, and 7 according to embodiments of the inventive concept. The circuit diagrams of FIGS. 6A through 8 are described below with reference to the timing diagram of FIG. 9.

FIG. 6A illustrates a first connection state for the first and second switch units 1230 and 1250, and FIG. 6B illustrates a second connection state for the first and second switch units 1230 and 1250. Each switch block of the first switch unit 1230 may include at least one switch. For example, as illustrated in FIGS. 6A and 6B, each switch block may include two switches. The first switch block SWI1 includes a first switch SWI1_1 and a second switch SWI1_2. Similarly, the second to Mth switch blocks SWI2 to SWIm respectively include first switches SWI2_1, SWI3_1, . . . , and respectively include second switches SWI2_2, SWI3_2, . . . . The first switches SWI1_1 to SWIm_1 of the switch blocks SWI1 to SWIm are switched on according to a first control signal Ctrl_IN, and the second switches SWI1_2 to SWIm_2 are switched on according to an inverted first control signal Ctrl_INB.

Each switch block of the second switch unit 1250 may also include at least one switch. For example, the (M+1)th switch block SWO1 may include a first switch SWO1_1 and a second switch SWO1_2. The first switch SWO1_1 is connected to an output terminal of the first main buffer 1241_1, and the second switch SWO1_2 is connected to an output terminal of the sub buffer 1242. Similarly, in the (M+2)th switch block SWO2, a first switch SWO2_1 is connected to an output terminal of the second main buffer 1241_2 and a second switch SWO2_2 is connected to an output terminal of the first main buffer 1241_1. In the second switch unit 1250, first switches SWIO_1 to SWOm_1 of the switch blocks SWO1 to SWOm are switched on according to a second control signal Ctrl_OUT, and second switches SWIO_2 to SWOm_2 are switched on according to an inverted second control signal Ctrl_OUTB.

Various control signals as illustrated in FIG. 9 are supplied to the source driver 1200. For example, referring to FIG. 1, the various control signals CONT1 may be supplied to the source driver 1200 from the timing controller 1400. The various control signals CONT1 may include a polarity control signal POL and control signals Ctrl_IN, Ctrl_INB, Ctrl_OUT, Ctrl_OUTB, Ctrl_CS, and Ctrl_CSB illustrated in FIG. 9. The value of the polarity control signal POL is inverted for scan units. The clock signal CLK1 is generated based on the polarity control signal POL, and the control signals Ctrl_IN, Ctrl_INB, Ctrl_OUT, Ctrl_OUTB, Ctrl_CS, and Ctrl_CSB may be generated using the clock signal CLK1.

When the first switch unit 1230 has the first connection state, the first control signal Ctrl_IN has a first logic level (e.g., a logical “high”), and the inverted first control signal Ctrl_INB has a second logic level (e.g., a logical “low”). Thus, in the switch blocks SWI1 to SWIm of the first switch unit 1230, the first switches SWI1_1 to SWIm_1 are turned ON and the second switches SWI1_2 to SWIm_2 are turned OFF. Outputs of the switch blocks SWI1 to SWIm are respectively input to the first to Mth main buffers 1241_1 to 1241_{—}m.

When the second switch unit 1250 has the first connection state, the second control signal Ctrl_OUT has the first logic level and the inverted second control signal Ctrl_OUTB has the second logic level. Thus, in the switch blocks SWO1 to SWOm of the second switch unit 1250, the first switches SWIO_1 to SWOm_1 are turned ON and the second switches SWO1_2 to SWOm_2 are turned OFF. Thus, outputs of the M main buffers 1241_1 to 1241_{—}m are respectively supplied as the data signals Y1 to Ym to the data lines DL1 to DLm.

When the first switch unit 1230 has the second connection state, the first control signal Ctrl_IN has the second logic level and the inverted first control signal Ctrl_INB has the first logic level. In the switch blocks SWI1 to SWIm of the first switch unit 1230, the first switches SWI1_1 to SWIm_1 are turned OFF and the second switches SWI1_2 to SWIm_2 are turned ON, according to the first control signal Ctrl_IN and the inverted first control signal Ctrl_INB. Thus, the gradation voltages V1 to Vm are respectively applied to the sub buffer 1242 and the first to (M−1)th main buffers 1241_1 to 1241_{—}m−1 via the first switch unit 1230. When the second switch unit 1250 has the second connection state, the second control signal OUT has the second logic level and the inverted second control signal Ctrl_OUTB has the first logic level. In switch blocks SWO1 to SWOm of the second switch unit 1250, the first switches SWO1_1 to SWOm_1 are turned OFF and the second switches SWO1_2 to SWOm_2 are turned ON. Thus, the outputs of the sub buffer 1242 and the first to (M−1)th main buffers 1241_1 to 1241_{—}m−1 are respectively supplied as the data signals Y1 to Ym to the data lines DL1 to DLm.

Charge sharing may be performed so that voltages of the data lines DL1 to DLm may be approximately equal to a common voltage VCOM after a selected gate line is driven and before a subsequent gate line is driven. Referring to FIG. 9, during charge sharing, both the second control signal Ctrl_OUT and the inverted second control signal Ctrl_OUTB have the first logic level. Thus, as illustrated in FIG. 7, the second switch unit 1250 has a third connection state, and in this case, all of the switches included in the second switch unit 1250 are turned ON. During the charge sharing, all of the data lines DL1 to DLm are electrically connected and charges contained in the connected data lines DL1 to DLm are shared. In other words, positive charges stored in some of the data lines DL1 to DLm and negative charges stored in the other data lines are shared, and the voltages of the data lines DL1 to DLm are thus substantially equal to the common voltage VCOM after the charge sharing is performed.

Since the second switch unit 1250 includes the switches connected in one direction, all of the switches may be turned ON to electrically connect the data lines DL1 to DLm with one another. Thus, charge sharing may be performed without having to use additional switches.

In order to perform charge sharing on the data lines DL1 to DLm, the data lines DL1 to DLm need to be maintained in a floated state during the charge sharing. Each of the buffers included in the buffer unit 1240 of the source driver 1200 includes means for controlling an output thereof to prevent an output of the buffer unit 1240 from being transmitted to the data lines DL1 to DLm during the charge sharing.

FIG. 8 is a circuit diagram of a buffer included in a buffer unit, according to an embodiment of the inventive concept. For convenience of explanation, FIG. 8 illustrates only one buffer, for example, the first main buffer 1241_1 included in the buffer unit 1240, but another main buffer or a sub buffer included in the buffer unit 1240 may be constructed similar to the first main buffer 1241_1.

The buffer 1241_1 receives and buffers gradation voltages V1 and V1B, and generates a data signal Y1. FIG. 8 illustrates that differential signals, e.g., the gradation voltages V1 and V1B, are input to the buffer 1241_1 and the buffer 1241_1 generates a single output signal, e.g., the data signal Y1, according to the differential signals. In FIG. 8, internal inputs PU and PD may be signals obtained by processing the gradation voltages V1 and V1B in the buffer 1241_1. The buffer 1241_1 may include an output driver 1243 and enable controllers 1244 and 1245. The output driver 1243 may include a pull-up PMOS transistor and a pull-down NMOS transistor. The enable controllers 1244 and 1245 may respectively control operations of the PMOS transistor and the NMOS transistor of the output driver 1243. The output driver 1243 receives the internal inputs PU and PD and generates an output signal according thereto, i.e., the data signal Y1.

The enable controllers 1244 and 1245 control the operation of the output driver 1243 according to enable control signals Ctrl_CSB and Ctrl_CS. Referring to FIG. 9, in a charge sharing period, the enable control signals Ctrl_CS and Ctrl_CSB are activated to disable a buffer unit. As described above, while the enable control signals Ctrl_CS and Ctrl_CSB are activated, both the second control signal Ctrl_OUT and the inverted second control signal Ctrl_OUTB are logical high.

When the buffer 1241_1 is enabled, the internal inputs PU and PD are supplied to the transistors of the output driver 1243, and the buffer 1241_1 outputs the data signal Y1 according to the internal inputs PU and PD. When the buffer 1241_1 is disabled according to the enable control signals Ctrl_CS and Ctrl_CSB, the internal inputs PU and PD are prevented from being transmitted to the output driver 1243, and a predetermined voltage is applied to gate terminals of the transistors of the output driver 1243 so as to turn OFF the transistors. Thus, an output terminal of the buffer 1241_1 is floated. FIG. 8 illustrates the buffer 1241_1, which is an analog type buffer, and that the enable controllers 1244 and 1245 include analog switches to control enabling/disabling of the buffer 1241_1, but the inventive concept is not limited thereto. For example, the buffer 1241_1 may be embodied as a digital type buffer, and the enable controllers 1244 and 1245 may include digital switches, the switching operations of which are controlled according to a digital control signal to control enabling/disabling of the buffer 1241_1.

The first and second data signals Y1 and Y2 illustrated in FIG. 9 are described below related to polarities of the data lines DL1 to DLm. The first and second data signals Y1 and Y2 are respectively transmitted via the first and second data lines DL1 and DL2. When a first gate line is selected, the first data signal Y1 having a positive polarity is supplied to the first data line DL1 and the second data signal Y2 having a negative polarity is supplied to the second data line DL2. Then, charge sharing is performed to control voltages of the first and second data line DL1 and DL2 to be approximately equal to the common voltage VCOM. When a second gate line is selected, the first data signal Y1 having a negative polarity is supplied to the first data line DL1 and the second data signal Y2 having a positive polarity is supplied to the second data line DL2. Such an operation is repeatedly performed on all of the gate lines of panel 1100 of FIG. 1.

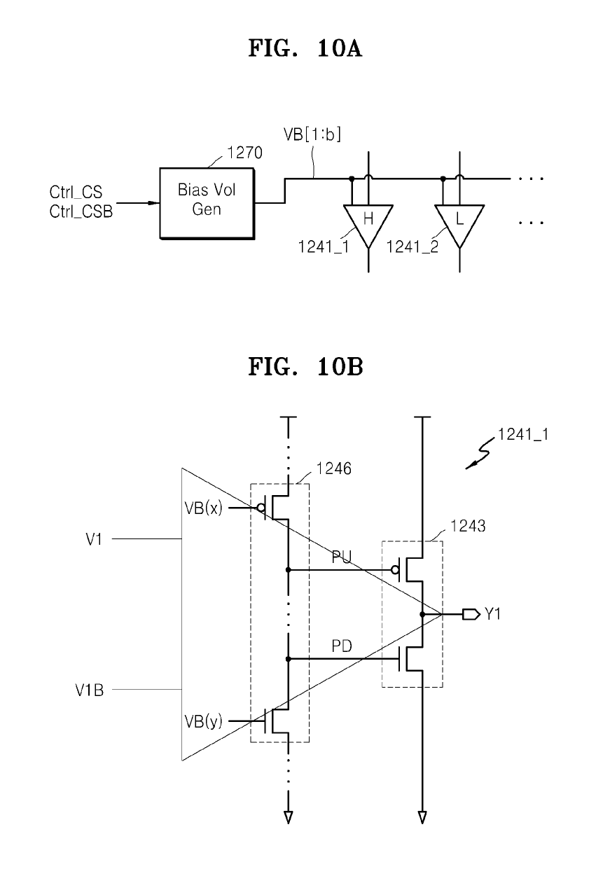

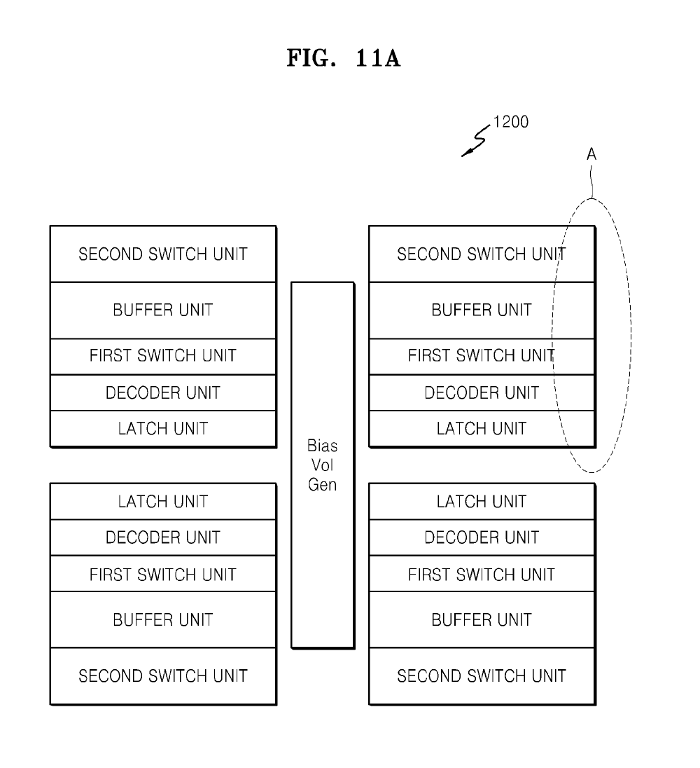

FIG. 10, including FIGS. 10A and 10B, illustrates a block diagram and a circuit diagram of a buffer included in a buffer unit according to embodiments of the inventive concept. FIG. 10A illustrates a case where the buffers of the buffer unit 1240 of FIG. 4 are controlled to be enabled/disabled by using bias voltages VB[1:a]. FIG. 10B is a circuit diagram of one of the buffers of FIG. 10(a) according to another embodiment of the inventive concept. For convenience of explanation, FIG. 10A illustrates only the first and second main buffers 1241_1 and 1241_2, and FIG. 10B illustrates the first main buffer 1241_1.

Referring to FIG. 10A, enabling/disabling of the buffers included in the buffer unit 1240 may be controlled by using the bias voltages VB[1:b] from a bias voltage generator 1270. When the buffer unit 1240 operates normally, each of the buffers of the buffer unit 1240 is biased by the bias voltages VB[1:b] and thus operates normally. However, during charge sharing, each of the buffers of the buffer unit 1240 is disabled by the bias voltages VB[1:b] to prevent a signal from being output from each of the buffers.

The bias voltage generator 1270 may generate the bias voltages VB[1:b] according to enable control signals Ctrl_CS and Ctrl_CSB to disable the buffer unit 1240 by using the bias voltages VB[1:b] during charge sharing. The bias voltage generator 1270 may be included in the source driver 1200 of FIG. 1 but may be disposed outside the source driver 1200. Each of the buffers of the buffer unit 1240 may receive a plurality of bias voltages, for example, the bias voltages VB[1:b] illustrated in FIG. 10A according to a structure thereof. The bias voltages VB[1:b] are commonly applied to the buffers of the buffer unit 1240.

As illustrated in FIG. 10B, each of the buffers, e.g., the first main buffer 1241_1, includes an output driver 1243 and a biasing circuit 1246. The biasing circuit 1246 may operate according to some of the bias voltages VB[1:b], e.g., bias voltages VB[x] and VB[y], from among the plurality of bias voltages VB[1:b]. Internal inputs PU and PD, which are to be supplied to the output driver 1243, are supplied to some nodes of the biasing circuit 1246. During charge sharing, the internal inputs PU and PD are respectively changed to have a power supply voltage and a ground voltage according to the bias voltages VB[x] and VB[y], and the changed internal inputs PU and PD prevent a signal from being output from the output driver 1243.

As illustrated in FIGS. 8 and 10, the size of each buffer may be minimized. In other words, the second switch unit 1250 includes switches that are relatively large to improve driving of data lines, whereas enable controllers included in each buffer may be embodied using a transistor that is relatively small. Otherwise, referring to FIG. 10B, no enable controllers are included in the first main buffer 1241_1 and enabling/disabling of the first main buffer 1241_1 is controlled using the bias voltages VB[x] and VB[y]. Thus, the size of the first main buffer 1241_1 may be minimized. That is, according to an embodiment of the inventive concept, the size of the buffer unit 1240 may be minimized and no additional switches are needed to electrically connect data lines during charge sharing, thereby reducing the whole size of the source driver 1200.

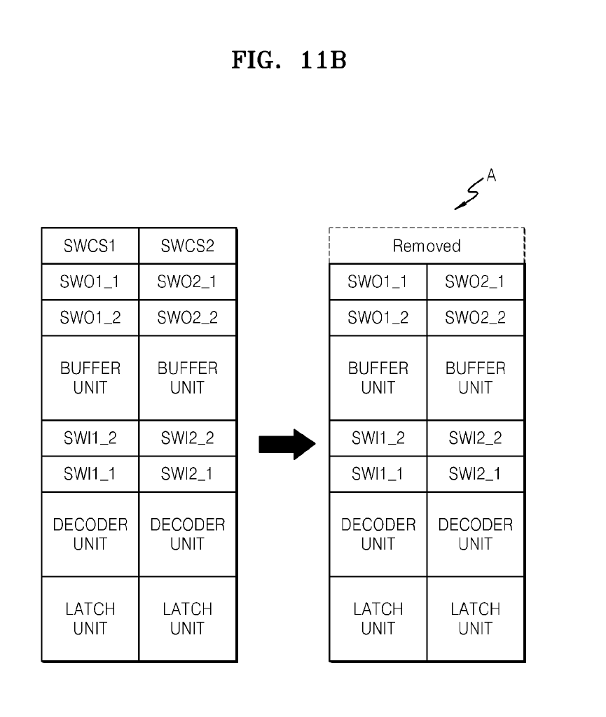

FIGS. 11A and 11B are possible layout diagrams for the source driver 1200 of FIG. 1 according to embodiments of the inventive concept. Referring to FIG. 11A, a source driver 1200 may include a driving block that may be divided into several sub driving blocks, and a bias voltage generator for applying a bias voltage to the sub driving blocks. Each of the sub driving blocks may include a latch unit, a decoder unit, a first switch unit, a second switch unit, and a buffer unit.

FIG. 11B is a layout block in which the source driver 1200 of FIG. 11A is compared with a conventional source driver in terms of their sizes. FIG. 11B specifically illustrates a portion A of the source driver 120 of FIG. 11A. Referring to FIG. 11B, the conventional source driver includes switches SWO1_1, SWO2_1, SWO1_2, and SWO2_2 to transmit an output of a buffer unit to data lines, and additional switches SWCS1 and SWCS2 to electrically connect all of the data lines during charge sharing. On the other hand, in the source driver 1200 illustrated in FIG. 11B, second switch units SWO1_1, SWO2_1, SWO1_2, and SWO2_2 not only perform switching to transmit data signals but also perform switching to electrically connect all of the data lines. Thus, additional switches are not needed in the source driver 1200, unlike in the conventional source driver.

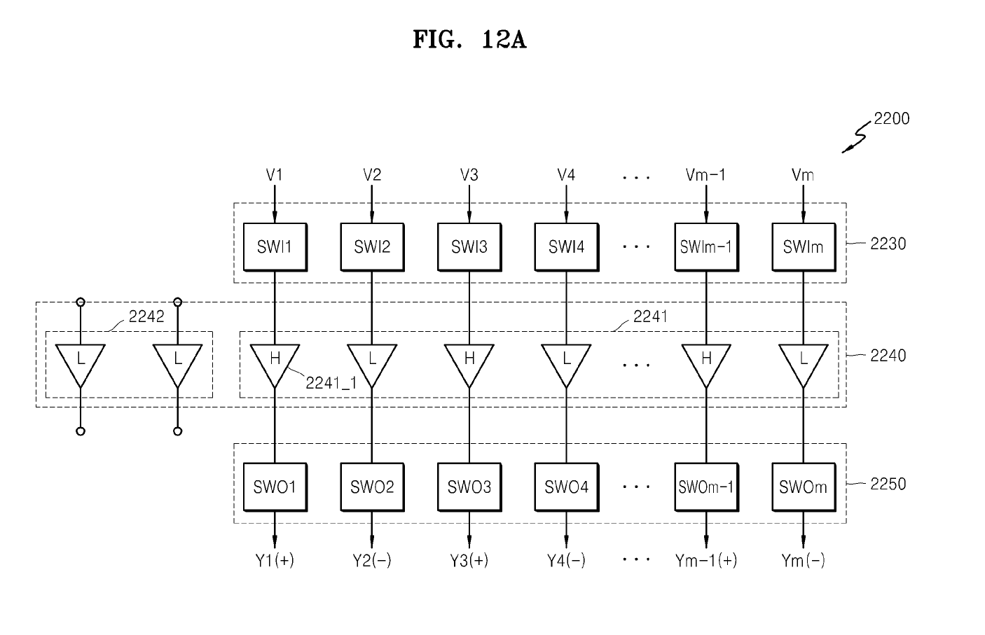

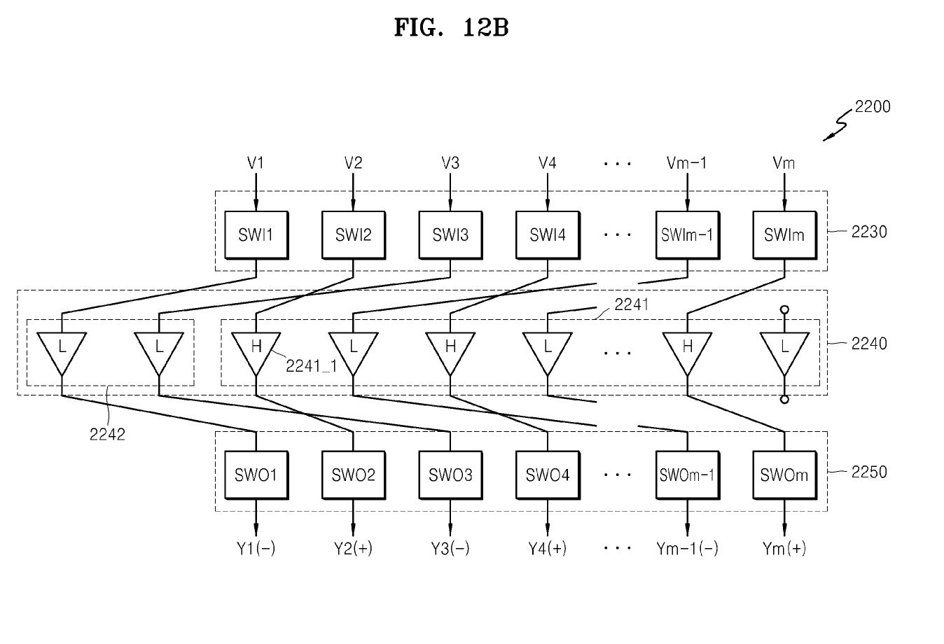

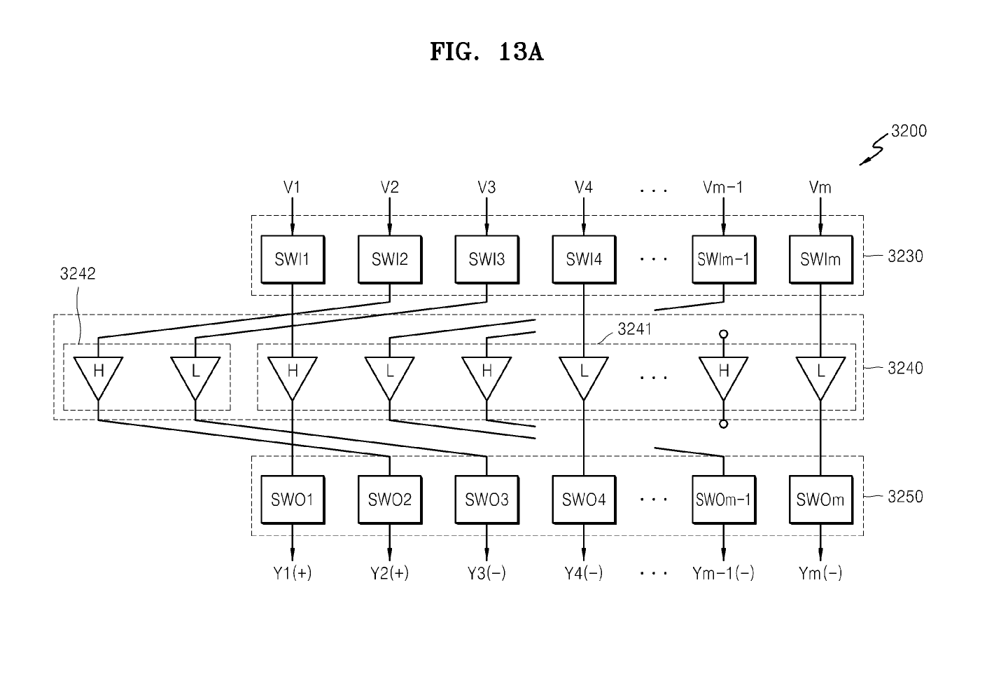

FIGS. 12A and 12B are block diagrams of a source driver 2200 according to another embodiment of the inventive concept. For convenience of explanation, FIGS. 12A and 12B illustrate only a first switch unit 2230 and a second switch unit 2250 and a buffer unit 2240 included in the source driver 2200.

Referring to FIGS. 12A and 12B, the source driver 2200 includes the first switch unit 2230, the buffer unit 2240, and the second switch unit 2250. The first switch unit 2230 includes M switch blocks SWI1 to SWIm for respectively receiving M gradation voltages V1 to Vm. Each of the switch blocks SWI1 to SWIm includes at least one switch (not shown), and applies gradation voltages V1 to Vm to the buffer unit 2240, based on switching performed by the at least one switch.

The buffer unit 2240 includes a first buffer unit 2241 and a second buffer unit 2242. The first buffer unit 2241 includes M main buffers corresponding to M switch blocks SWI1 to SWIm. The M main buffers include positive buffers each generating a positive polarity data signal, and negative buffers each generating a negative polarity data signal. Also, the second buffer unit 2242 includes at least one sub buffer. FIGS. 12A and 12B illustrate that two sub buffers for outputting signals having the same polarity are included as an example of the at least one sub buffer in the second buffer unit 2242. The second buffer unit 2242 is disposed at a first side of the first buffer unit 2241, e.g., adjacent to the first main buffer 2241_1. The at least one sub buffer of the second buffer unit 2242 may generate a signal, the polarity of which is different from the polarity of a signal generated by the first main buffer 2241_1. For example, if the first main buffer 2241_1 is a positive buffer, the at least one sub buffer may be a negative buffer.

The second switch unit 2250 is connected to an output terminal of the buffer unit 2240, and receives data signals Y1 to Ym from the buffer unit 2240. The second switch unit 2250 includes M switch blocks SWO1 to SWOm corresponding to M data signals Y1 to Ym. The M switch blocks SWO1 to SWOm are respectively connected to M buffers from among a plurality of buffers, e.g., (M+2) buffers, which are included in the buffer unit 2240. FIGS. 12A and 12B illustrate that a panel (not shown) is driven according to the dot inversion method, according to an embodiment of the inventive concept. Specifically, FIG. 12A illustrates a first connection state of the first and second switch units 2230 and 2250, and FIG. 12B illustrates a second connection state of the first and second switch units 2230 and 2250.

Referring to FIG. 12A, when the first and second switch units 2230 and 2250 have the first connection state, the first switch unit 2230 respectively applies the M gradation voltages V1 to Vm to the M main buffers. The second switch unit 2250 is connected to output terminals of the M main buffers, receives the data signals Y1 to Ym from the M main buffers, and supplies the data signals Y1 to Ym to M data lines (not shown). In the M main buffers, positive buffers and negative buffers are alternately disposed. Thus, the odd-numbered data signals Y1, Y3, . . . through to Ym−1 have positive polarities, and the even-numbered data signals Y2, Y4, . . . through to Ym have negative polarities.

Referring to FIG. 12B, when the first and second switch units 2230 and 2250 have the second connection state, the first switch unit 2230 applies the M gradation voltages V1 to Vm to two sub buffers and (M−2) main buffers from among the M main buffers. The second switch unit 2250 is connected to output terminals of the two sub buffers and the (M−2) main buffers, receives the data signals Y1 to Ym from the two sub buffers and the (M−2) main buffers, and supplies the data signals Y1 to Ym to the M data lines. Thus, the odd-numbered data signals Y1, Y3, . . . through to Ym−1 have negative polarities and the even-numbered data signals Y2, Y4, . . . through to Ym have positive polarities.

Referring to FIGS. 12A and 12B, when the first and second switch units 1230 and 1250 have the first connection state, a Kth gradation voltage is applied to a Kth main buffer corresponding to a Kth channel. When the first and second switch units 1230 and 1250 have the second connection state, the Kth gradation voltage is applied to a buffer disposed at a first side of the Kth main buffer corresponding to a Kth channel. For example, when the first and second switch units 1230 and 1250 have the second connection state, the Kth gradation voltage is applied to a (K−2)th main buffer corresponding to a (K−2)th channel. First and second gradation voltages V1 and V2 are respectively applied to first and second sub buffers.

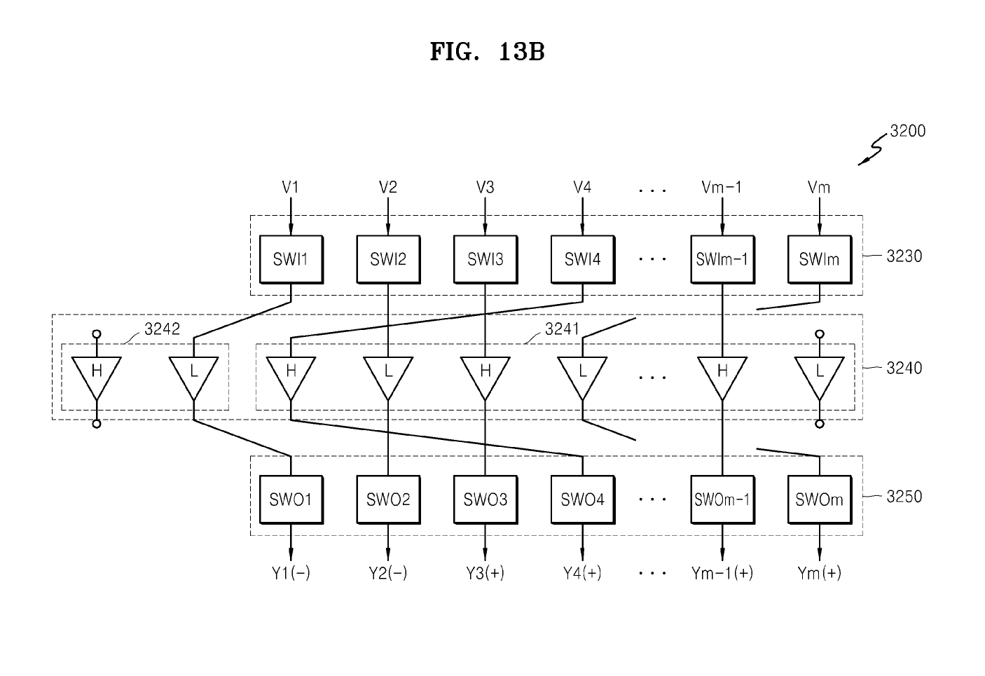

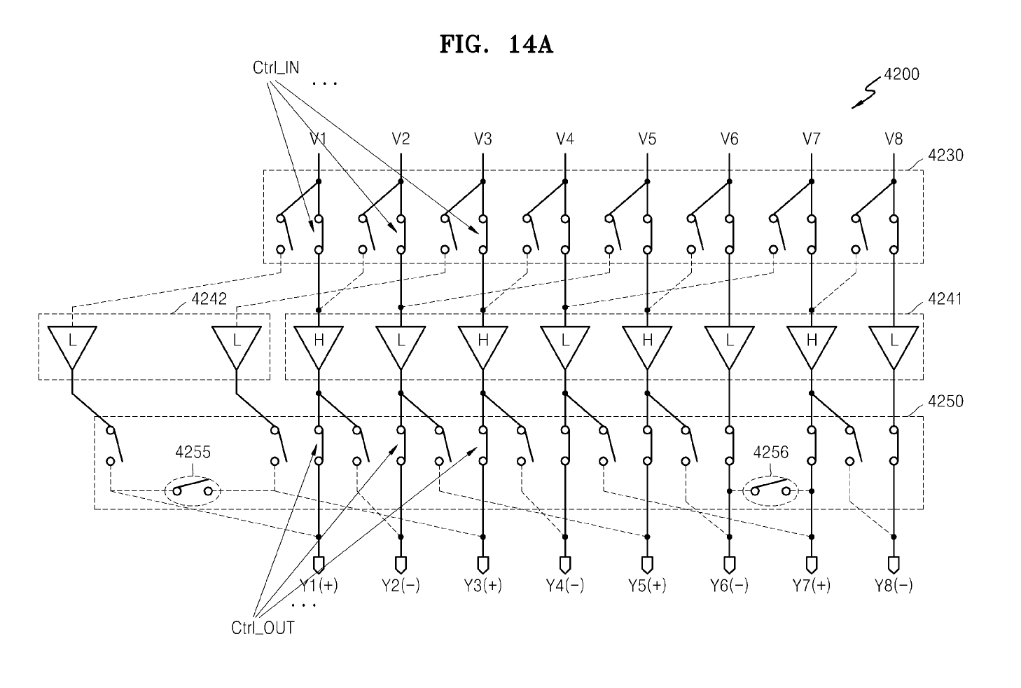

FIGS. 13A and 13B are block diagrams illustrating a source driver 3200 according to embodiments of the inventive concept. For convenience of explanation, FIGS. 13A and 13B illustrate only a first switch unit 3230 and a second switch unit 3250 and a buffer unit 3240 included in the source driver 3200.

Referring to FIGS. 13A and 13B, the source driver 3200 includes the first switch unit 3230, the buffer unit 3240, and the second switch unit 3250. The first switch unit 3230 includes M switch blocks SWI1 to SWIm corresponding to M channels of the source driver 3200. The buffer unit 3240 includes a first buffer unit 3241 and a second buffer unit 3242. The first buffer unit 3241 includes M main buffers corresponding to the M channels. In the M main buffers, positive buffers and negative buffers are alternately disposed. The second buffer unit 3242 includes two sub buffers, one of which is a positive buffer and the other of which is a negative buffer. The second switch unit 3250 includes M switch blocks SWO1 to SWOm corresponding to the M channels. FIGS. 13A and 13B illustrate that a panel (not shown) is driven according to the H2 dot inversion method, according to an embodiment of the inventive concept. Specifically, FIG. 13A illustrates a first connection state of the first and second switch units 3230 and 3250, and FIG. 13B illustrates a second connection state of the first and second switch units 3230 and 3250.

When the first and second switch units 3230 and 3250 have the first connection state, some of the switch blocks of the first switch unit 3230 receive gradation voltages and apply them to corresponding main buffers. The other switch blocks of the first switch unit 3230 receive gradation voltages and apply them either to a main buffer or a sub buffer disposed at a first side of the corresponding main buffers. For example, regarding first to fourth switch blocks SWI1 to SWI4 of the first switch unit 3230, the first and third switch blocks SWI1 and SWI3 respectively apply gradation voltages V1 and V4 to corresponding first and fourth main buffers, and a second switch block SWI2 applies a gradation voltage V2 to a first sub buffer (positive buffer) of the second buffer unit 3242. A third switch block SWI3 applies a gradation voltage V3 to a second sub buffer (negative buffer) of the second buffer unit 3242.

Outputs of the first and fourth main buffers are supplied to first and fourth data lines DL1 and DL4 via the first and fourth switch blocks SWO1 and SWO4 of the second switch unit 3250. Outputs of the first and second sub buffers are supplied to the second and third data lines DL2 and DL3 via the second and third switch blocks SWO2 and SWO3 of the second switch unit 3250. Thus, first and second data signals Y1 and Y2 have positive polarity, and third and fourth data signals Y3 and Y4 have negative polarity. The above description is also applied to the other switch blocks, and thus, pixels of the panel are driven according to the H2 dot inversion method.

When the first and second switch units 3230 and 3250 have the second connection state, the second and third switch blocks SWI2 and SWI3 of the first switch unit 3230 receive the gradation voltages V2 and V3 and apply them to the corresponding second and third main buffers, respectively. The first switch block SWI1 applies the gradation voltage V1 to the second sub buffer (negative buffer) of the second buffer unit 3242, and the fourth switch block SWI4 applies the gradation voltage V4 to the first main buffer (positive buffer). Outputs of the second and third main buffers are supplied to the second and third data lines DL2 and DL3 via the second and third switch blocks SWO2 and SWO3 of the second switch unit 3250. Outputs of the second sub buffer and the first main buffer are supplied to the first and fourth data lines DL1 and DL4 via the first and fourth switch blocks SWO1 and SWO4. Thus, the first and second data signals Y1 and Y2 have negative polarities, and the third and fourth data signals Y3 and Y4 have positive polarities.

Referring to FIGS. 13A and 13B, according to a connection state of the first and second switch units 1230 and 1250, a Kth gradation voltage is applied to either a Kth main buffer corresponding to a Kth channel or a buffer disposed at a first side of the Kth main buffer. For example, the fourth gradation voltage V4 is applied to the fourth main buffer (negative buffer) when the first and second switch units 1230 and 1250 have the first connection state, and is applied to a positive buffer (first sub buffer) at a first side of the fourth main buffer when the first and second switch units 1230 and 1250 have the second connection state. On the other hand, the third gradation voltage V3 is applied to the third main buffer (negative buffer) when the first and second switch units 1230 and 1250 have the second connection state, and is applied to a negative buffer (second sub buffer) at a first side of the third main buffer when the first and second switch units 1230 and 1250 have the first connection state.

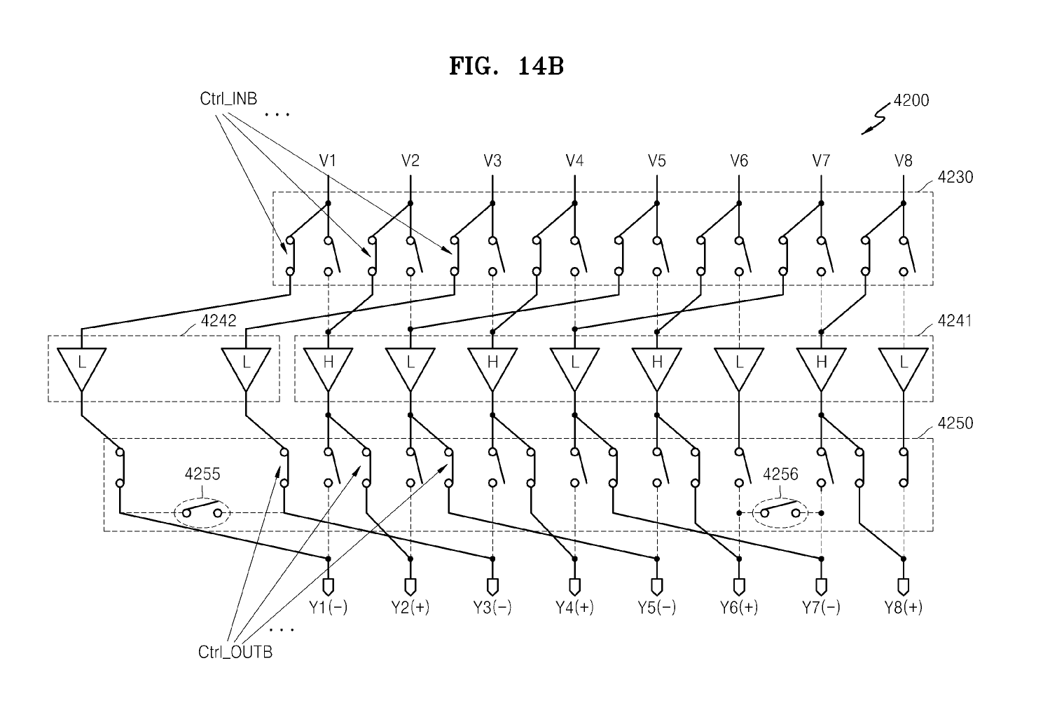

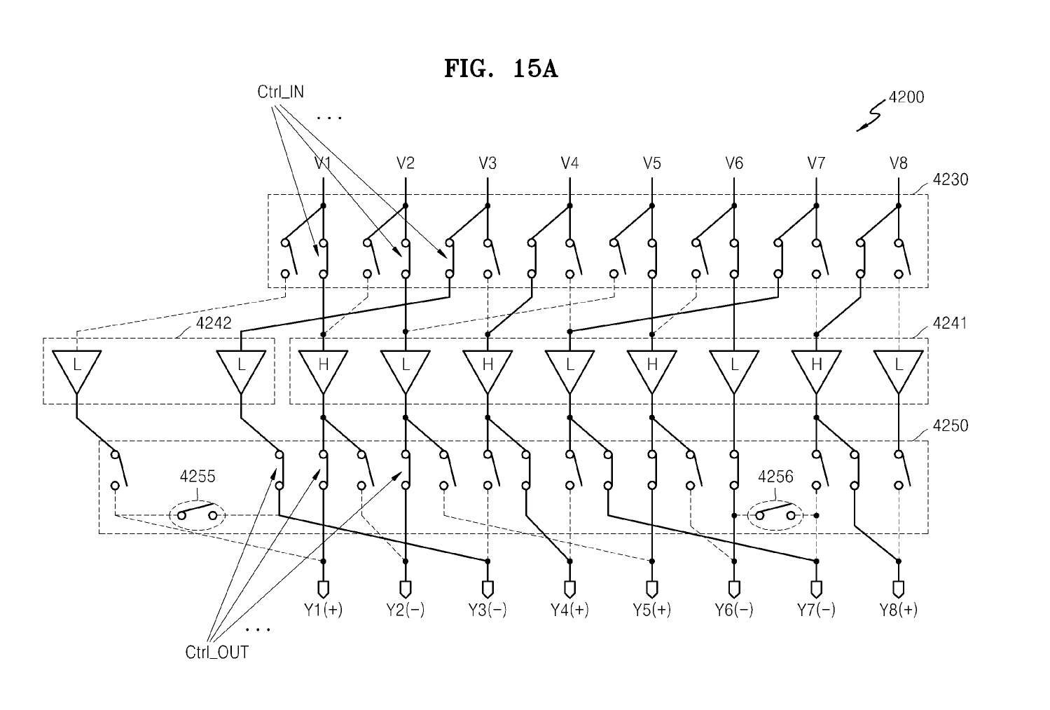

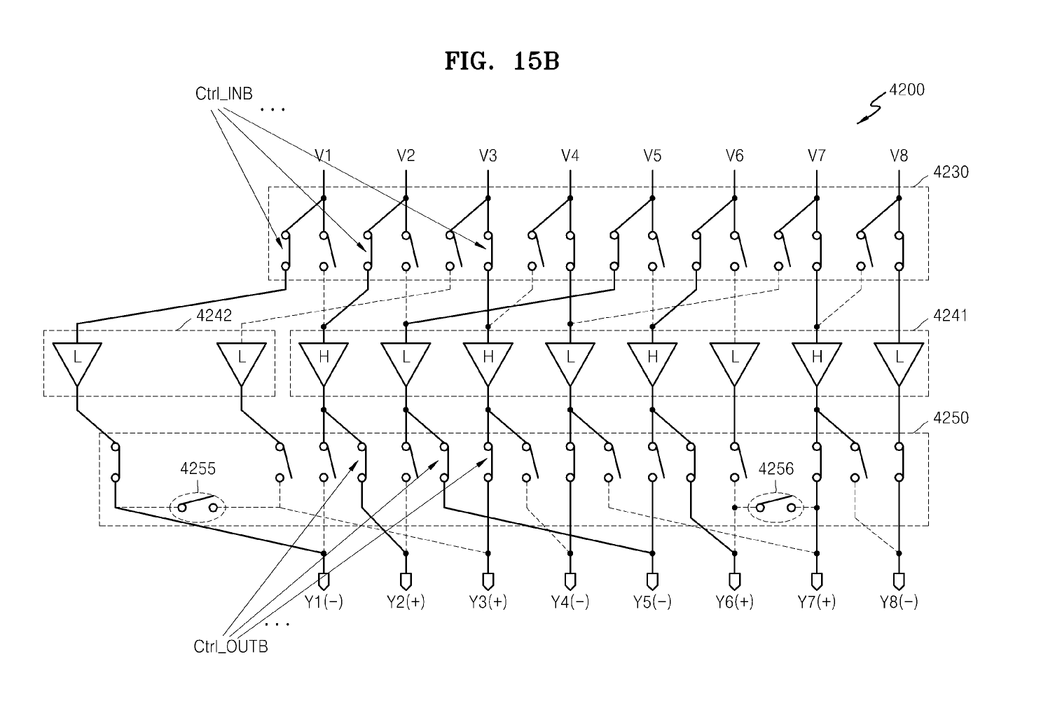

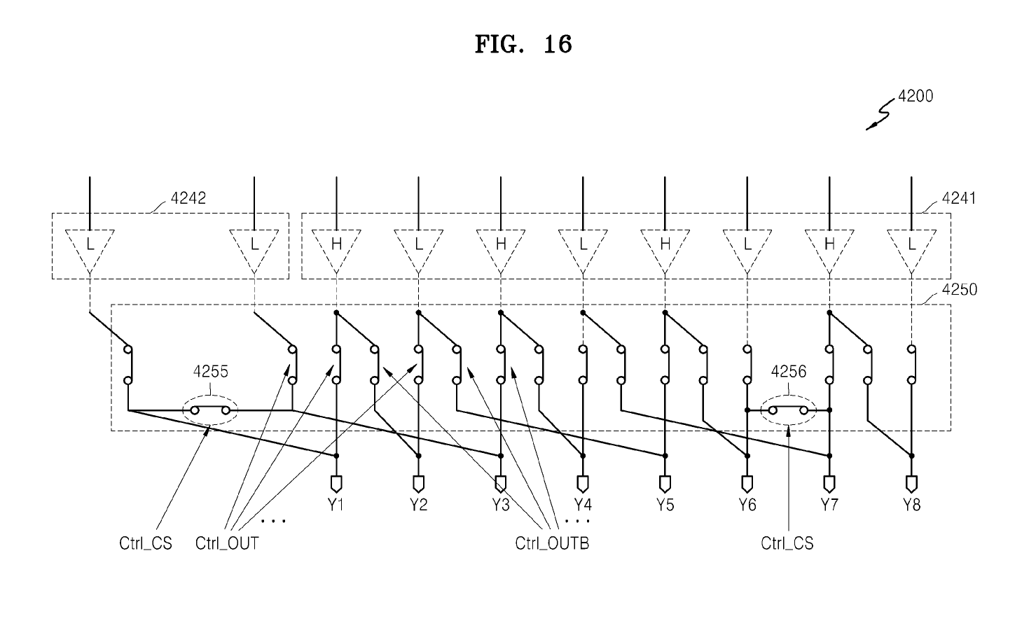

FIGS. 14A, 14B, 15A, 15B and 16 are block diagrams illustrating a source driver 4200 according to embodiments of the inventive concept. According to the current embodiment, the source driver 4200 may drive a panel (not shown) based on both the dot inversion method and the H2 dot inversion method. Specifically, FIGS. 14A and 14B illustrate a connection state for first and second switch units 4230 and 4250 that drive the panel according to the dot inversion method. FIGS. 15A and 15B illustrate a connection state for the first and second switch units 4230 and 4250 that drive the panel according to the H2 dot inversion method. FIG. 16 illustrates a connection state for the second switch unit 4250 that performs charge sharing. For convenience of explanation, it is assumed that in the illustrated embodiments related to the source driver 4200 include eight (8) channels.

FIG. 14A illustrates a first connection state for the first and second switch units 4230 and 4250. When the first switch unit 4230 has the first connection state, first to eighth gradation voltages V1 to V8 are respectively applied to first to eighth main buffers of a first buffer unit 4241. When the second switch unit 4250 has the first connection state, data signals Y1 to Y8 are supplied to a panel (not shown) from the first to eighth main buffers. The odd-numbered data signals Y1, Y3, Y5, and Y7 have positive polarities, and the even-numbered data signals Y2, Y4, Y6, and Y8 have negative polarities.

Referring to FIG. 14B, when the first switch unit 4230 has the second connection state, odd-numbered gradation voltages V1, V3, V5, and V7 are respectively applied to negative buffers and even-numbered gradation voltages V2, V4, V6, an V8 are respectively applied to positive buffers. To this end, each of the first to eighth gradation voltages V1 to V8 is applied to either a main buffer or a sub buffer disposed at a first side of corresponding main buffer. For example, the first and third gradation voltages V1 and V3 are respectively applied to first and second sub buffers, and the fifth and seventh gradation voltages V5 and V7 are respectively applied to second and fourth main buffers each outputting a negative polarity data signal. The even-numbered gradation voltages V2, V4, V6, and V8 are respectively applied to first, third, fifth, and seventh main buffers each outputting a positive polarity data signal. Thus, the odd-numbered data signals Y1, Y3, Y5, and Y7 have negative polarities, and the even-numbered data signals Y2, Y4, Y6, and Y8 have positive polarities.

If switches are connected to drive the panel based on both the dot inversion method and the H2 dot inversion method, some of data lines and some of the other data lines may not be electrically connected even when all of M switch blocks included in the second switch unit 4250 are turned ON. For example, as illustrated in FIGS. 14A and 14B, when all of the M switch blocks of the second switch unit 4250 are turned ON, first, second, fifth, and sixth data lines are electrically connected and third, fourth, seventh, and eighth data lines are electrically connected.

Thus, in order to electrically connect all of the data lines, the second switch unit 4250 may include not only the M switch blocks but also at least one additional switch, e.g., additional switches 4255 and 4256 for performing charge sharing. The additional switches 4255 and 4256 are turned OFF when the data signal Y1 to Y8 are transmitted, and are turned ON when charge sharing is performed. The additional switches 4255 and 4256 may be switched on according to control signals Ctrl_CS and Ctrl_CSB illustrated in FIG. 9. Even though the source driver 4200 includes a plurality of channels, a number of additional switches for charge sharing may be limited to one or two. Thus, the number of switches for charge sharing may be prevented from being increased in proportion to the number of channels.

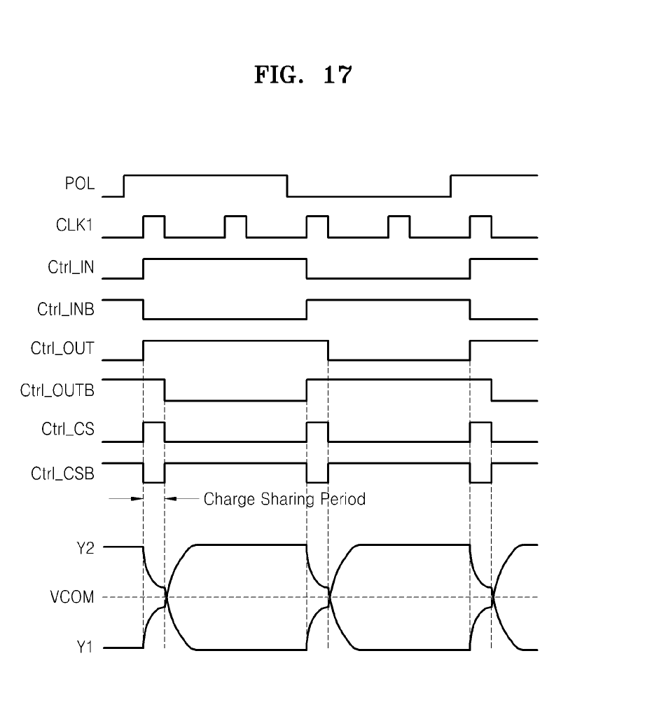

Operations of the source driver 4200 illustrated in FIGS. 15A and 15B are described below with reference to the timing diagram of FIG. 17. As described above, the source driver 4200 illustrated in FIGS. 15A and 15B drives a panel (not shown) according to the H2 dot inversion method. FIGS. 15A and 15B illustrate that the source driver 4200 inverts the polarity of each channel for every two scan units, as illustrated in FIG. 3(b). The logic level of a polarity control signal POL is inverted for every two scan units, and a frequency of a clock signal CLK1 may double that of the polarity control signal POL.

When a first control signal Ctrl_IN has a first logic level and an inverted first control signal Ctrl_INB has a second logic level, the first switch unit 4230 has the first connection state. When a second control signal Ctrl_OUT has the first logic level and an inverted first control signal Ctrl_OUTB has the second logic level, the second switch unit 4250 has the first connection state. When the first and second switch units 4230 and 4250 have the first connection state, second and third gradation voltages V2 and V3 and sixth and seventh gradation voltages V6 and V7 are applied to negative buffers, and the other gradation voltages V1, V4, V5, and V8 are applied to positive buffers. For example, the first and second gradation voltages V1 and V2 are respectively applied to corresponding first and second main buffers, and the fifth and sixth gradation voltages V5 and V6 are respectively applied to corresponding fifth and sixth main buffers. On the other hand, the third and seventh gradation voltages V3 and V7 are respectively applied to negative buffers, e.g., a second sub buffer and a fourth main buffer, which are disposed at the first side of corresponding buffers, and the fourth and eighth gradation voltages V4 and V8 are respectively applied to positive buffers, e.g., a third main buffer and a seventh main buffer, at the first side of corresponding buffers. Thus, second, third, sixth, and seventh data signals Y2, Y3, Y6, and Y7 have negative polarities, and the other data signals V1, V4, V5, and V8 have positive polarities.

Then, the first control signal Ctrl_IN has the second logic level and the inverted first control signal Ctrl_INB has the first logic level, and thus, the first switch unit 4230 has the second connection state. Also, the second control signal Ctrl_OUT has the second logic level and the inverted first control signal Ctrl_OUTB has the first logic level, and thus, the second switch unit 4250 has the second connection state. When the first and second switch units 4230 and 4250 have the second connection state, the second and third gradation voltages V2 and V3 and the sixth and seventh gradation voltages V6 and V7 are applied to positive buffers, and the other gradation voltages V1, V4, V5, and V8 are applied to negative buffers. For example, the third and fourth gradation voltages V3 and V4 are respectively applied to the corresponding third and fourth main buffers, and the seventh and eighth gradation voltages V7 and V8 are respectively applied to the corresponding seventh and eighth main buffers. The first and fifth gradation voltages V1 and V5 are respectively applied to negative buffers, e.g., a first sub buffer and a second main buffer, which are disposed at the first side of corresponding buffers, and the second and sixth gradation voltages V2 and V6 are respectively applied to positive buffers, e.g., a first main buffer and a fifth main buffer, which are disposed at the first side of corresponding buffers. Thus, the second, third, sixth, and seventh data signals Y2, Y3, Y6, and Y7 have positive polarities and the other data signals V1, V4, V5, and V8 have negative polarities.

Referring to FIGS. 15A and 15B, the polarity of each channel is changed for every two scan units, and thus, the logic level of the polarity control signal POL is inverted for every two scan units. However, the inventive concept is not limited thereto and those skilled in the art will recognize that the polarity of each channel may be inverted for every scan unit by adjusting the signal definitions shown in FIG. 17.

FIG. 16 is a circuit diagram illustrating an operation of the source driver 4200 to perform charge sharing between data lines, according to an embodiment of the inventive concept. The charge sharing of FIG. 16 may be performed in the same manner, regardless of whether the source driver 4200 drives a panel (not shown) based on the dot inversion method or the H2 dot inversion method. During the charge sharing, both a second control signal Ctrl_OUT and an inverted first control signal Ctrl_OUTB have a first logic level, and an enable control signal Ctrl_CS is activated. Thus, the second switch unit 4250 has a third connection state, and all of switches of the second switch unit 4250 are turned ON to electrically connect data lines (not shown). Also, during the charge sharing, the enable control signal Ctrl_CS is activated and all of the buffers included in the buffer unit 4240 are disabled.

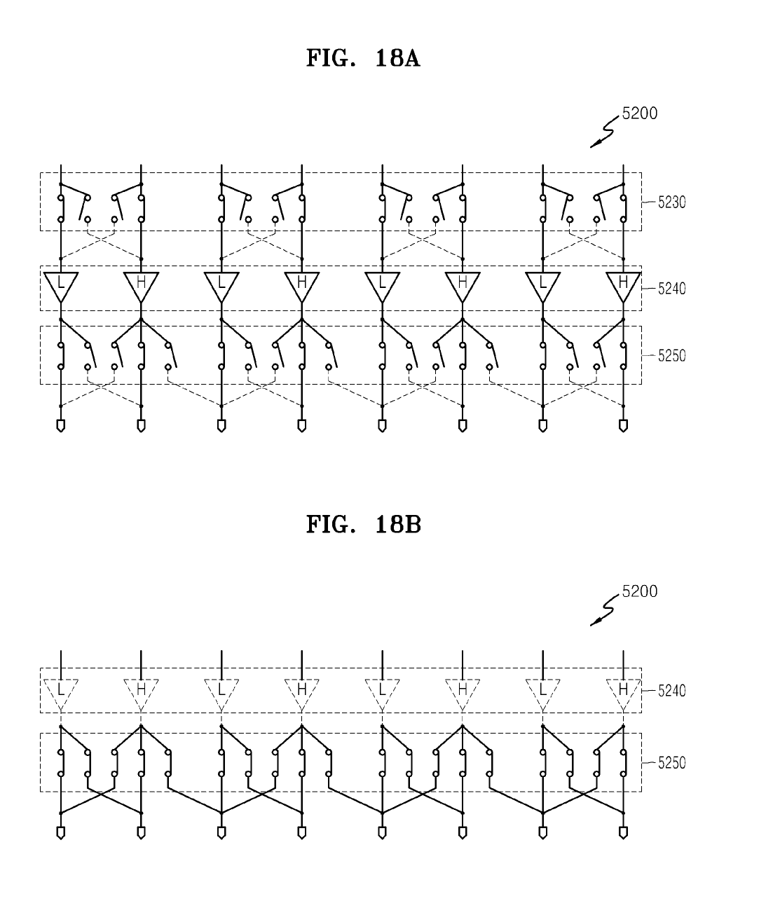

FIGS. 18A and 18B are block diagrams for a source driver 5200 according to embodiments of the inventive concept. Referring to FIGS. 18A and 18B, in the source driver 5200, two buffers form a pair of buffers to share inputs to or outputs from and a number of additional switches used to perform charge sharing may be less than that used by conventional source drivers.

FIG. 18A illustrates one approach to driving a panel (not shown) using the dot inversion method according to embodiments of the inventive concept. For convenience of explanation, FIG. 18A illustrates a connection state for only one of first and second switch units 5230 and 5250.

Referring to FIG. 18A, in a buffer unit 5240, buffers are arranged in such a manner that every two buffers form a pair of buffers. Also, each of positive buffers and each of negative buffers form a pair of buffers to share inputs to or outputs from. Each pair of buffers drive a pair of data lines. For example, when the first and second switch units 5230 and 5250 have a first connection state, a first gradation voltage V1 is applied to a first main buffer and a second gradation voltage V2 is applied to a second main buffer. When the first and second switch units 5230 and 5250 have a second connection state, the first gradation voltage V1 is applied to the second main buffer and the second gradation voltage V2 is applied to the first main buffer.

During charge sharing, all of the data lines must be electrically connected and maintained at a floated state. To this end, all of the switches connected to output terminals of buffers should be turned OFF, additional switches are needed to connect data lines of each pair of data lines, and additional switches are needed to electrically connect a plurality of pairs of data lines. In contrast, according to the embodiment of FIG. 18A, the buffers included in the buffer unit 5240 are configured as illustrated in FIG. 8 or FIG. 10, in which each of the buffers of the buffer unit 5240 includes enable controllers (not shown) to float the output terminals thereof. Charge sharing may be performed by floating the output terminal of the buffer unit 5240 according to the enable control signals Ctrl_CS and Ctrl_CSB of FIG. 9 or 17 and turning ON all switches of the second switch unit 5250. In this case, the second switch unit 5250 includes only additional switches to connect a plurality of pairs of data lines but does not need additional switches to connect two data lines each other of each pair of data lines.

FIG. 18B illustrates another approach to the operation of the source driver 5200 performing charge sharing according to embodiments of the inventive concept. Charge sharing may be performed by turning ON all of the switches of the second switch unit 5250 and floating all of the outputs terminals of the buffers of the buffer unit 5240.

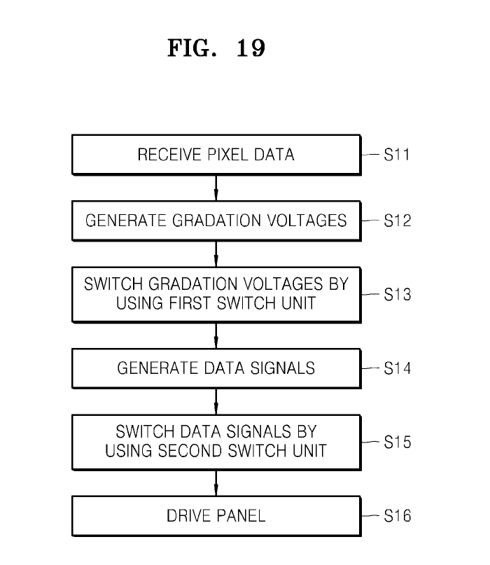

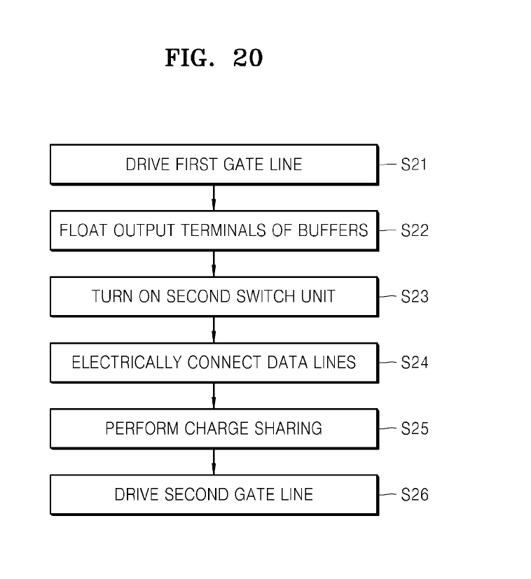

FIGS. 19 and 20 are flowcharts illustrating methods of operating a display driving circuit according to embodiments of the inventive concept. The exemplary methods illustrated in FIGS. 19 and 20 are described below using the display device 1000 and the source driver 1200 of FIGS. 1 and 2 as an operative context.

Referring to FIG. 19, the source driver 1200 receives pixel data that is constituted of digital signals (S11). Each of the pixel data may include at least one bit. The decoder unit 1220 of the source driver 1200 decodes the pixel data and generates gradation voltages V1 to Vm corresponding to M channels of the source driver 1200 (S12).

The first switch unit 1230 receives and switches the gradation voltages V1 to Vm and outputs a result of the switching to the buffer unit 1240 (S13). The buffer unit 1240 includes first and second buffer units (not shown), the first buffer unit includes M main buffers corresponding to the M channels, and the second buffer unit includes at least one sub buffer, e.g., N sub buffers. A connection state of the first switch unit 1230 is changed for scan units. For example, the first switch unit 1230 has a first connection state when odd-numbered gate lines are selected, and has a second connection state when even-numbered gate lines are selected. According to the connection state of the first switch unit 1230, the first switch unit 1230 controls a transmission path along which the gradation voltages V1 to Vm are applied to the buffer unit 1240.

Then, the buffer unit 1240 buffers the gradation voltages V1 to Vm and generates data signals Y1 to Ym (S14). The buffer unit 1240 includes a plurality of positive buffers and a plurality of negative buffers. Some of the gradation voltages V1 to Vm are applied to the plurality of positive buffers and the other gradation voltages are applied to the plurality of negative buffers. Thus, some of the data signals Y1 to Ym output from the buffer unit 1240 have positive polarities, and the other data signals have negative polarities. The data signals Y1 to Ym are supplied to the second switch unit 1250.

The second switch unit 1250 controls a transmission path along which the data signals Y1 to Ym are transmitted to the data lines DL1 to DLm (S15). When the first switch unit 1230 has the first connection state, the second switch unit 1250 also has the first connection state. The data signals Y1 to Ym corresponding to a scan line are supplied to the panel 1100 via the data lines DL1 to DLm, and the panel 1100 is driven according to the data signals Y1 to Ym (S16).

Referring to FIG. 20, a gate line, e.g., a first gate line, of the panel 1100 is driven according to the operations shown in FIG. 19 (S21). Then, another gate line, e.g., a second gate line, of the panel 1100 is driven. Before the second gate line is driven, the data lines DL1 to DLm are electrically connected to perform charge sharing. To this end, the output terminals of the buffers of the buffer unit 1240 are floated (S22). To perform operation S22, all main buffers and sub buffers included in a first buffer unit and a second buffer unit of the buffer unit 1240 may be floated.

All switches of the second switch unit 1250 are turned ON to electrically connect the data lines DL1 to DLm (S23). As described above, the second switch unit 1250 may include M switch blocks (not shown) to correspond to the M channels. Also, as illustrated in FIG. 16, a small number of switches may further be used to prevent data lines belonging to one group and data lines belonging to another group from among the data lines DL1 to DLm from being electrically insulated from one another. When all of the switches of the second switch unit 1250 are turned ON, the data lines DL1 to DLm are electrically connected to one another (S24). Then, charge sharing is performed between the data lines DL1 to DLm (S25). After the charge sharing is completed, the second gate line is driven (S26). The driving of the second gate line may be performed in the same way as or a similar way to the operations illustrated in FIG. 19. The driving may be repeatedly performed on N gate lines GL1 to GLn.

While the inventive concept has been particularly shown and described with reference to certain embodiments thereof, it will be understood that various changes in form and details may be made therein without departing from the scope of the following claims.

What is claimed is:

1. A display driving circuit comprising:
a buffer unit that receives gradation voltages and generates data signals that drive a panel, the buffer unit comprising a first buffer unit and a second buffer unit, wherein the first buffer unit comprises M main buffers corresponding to M data lines of the panel and the second buffer unit comprises N sub buffers;
a first switch unit that controls a transmission path along which the gradation voltages are applied to the buffer unit; and
a second switch unit comprising switches that control a transmission path along which the data signals are supplied to the data lines, wherein the switches are turned ON when charge sharing is performed,
where “M” is a positive integer, and “N” is a positive integer less than M.

2. The display driving circuit of claim 1, wherein each of the M main buffers and the N sub buffers comprises:
an output driver that generates a data signal; and
an enable controller that selectively enables a corresponding buffer in response to a first control signal.

3. The display driving circuit of claim 2, wherein the M main buffers and the N sub buffers are disabled during charge sharing.

4. The display driving circuit of claim 1, wherein a data signal output from one of the M main buffers is supplied to a first data line when the first and second switch units have a first connection state, and a data signal output from one of the N sub buffers is supplied to the first data line when the first and second switch units have a second connection state.

5. The display driving circuit of claim 1, wherein the M main buffers of the first buffer unit are disposed in parallel to correspond to the M data lines, and the second buffer unit is disposed on a first side of the first buffer unit.

6. The display driving circuit of claim 5, wherein a Kth gradation voltage is applied to either a corresponding Kth main buffer or one of a sub buffer and a main buffer disposed on the first side of the Kth main buffer in accordance with a connection state for the first switch unit, wherein “K” is a positive integer less than or equal to M.

7. The display driving circuit of claim 1, wherein the second switch unit further comprises; at least one additional switch that electrically connects the data lines, such that the at least one additional switch is turned OFF while the data signals are supplied to the data lines and is turned ON while charge sharing is performed.

8. A display driving circuit comprising:
a buffer unit that receives gradation voltages and generates data signals that drive a panel, the buffer unit comprising (M+N) buffers corresponding to M data lines;
a first switch unit that controls a transmission path along which the gradation voltages are applied to the buffer unit; and
a second switch unit that controls a transmission path along which the data signals are supplied to the M data lines,
wherein the first and second switch units are configured in a first connection state to output from M buffers belonging to a first group from among the (M+N) buffers, and are further configured in a second connection state to outputs of M buffers belonging to a second group from among the (M+N) buffers,
where “M” is a positive integer, and “N” is a positive integer less than M.

9. The display driving circuit of claim 8, wherein the second switch unit comprises first switches that control a transmission path along which the data signals are supplied, and all of the first switches are turned ON while charge sharing is performed.

10. The display driving circuit of claim 9, wherein the second switch unit comprises a second switch that electrically connects the data lines, such that the second switch is turned OFF while the data signals are output to the data lines and is turned ON while charge sharing is performed.

11. The display driving circuit of claim 9, wherein at least one from among the (M+N) buffers comprises:
an output driver that generates the data signal; and
an enable controller that selectively enables a corresponding buffer according to a first control signal.

12. The display driving circuit of claim 11, wherein the enable controller disables the corresponding buffer during charge sharing.

13. The display driving circuit of claim 8, wherein, when an odd-numbered gate line of the panel is driven, the M buffers belonging to the first group are selected, and when an even-numbered gate line of the panel is driven, the M buffers belonging to the second group are selected.

14. A source driver for driving data lines of a panel, the source driver comprising:
a buffer unit that receives gradation voltages and generating data signals that drive a panel, the buffer unit comprising a first buffer unit and a second buffer unit, wherein the first buffer unit comprises M main buffers corresponding to M data lines of the panel and the second buffer unit comprises N sub buffers;
a first switch unit that controls a transmission path along which the gradation voltages are applied to the buffer unit; and
a second switch unit comprising switches that control a transmission path along which the data signals are supplied to the data lines, wherein the switches are turned ON when charge sharing is performed,
wherein M is a positive integer, and “N” is a positive integer less than M.

15. The source driver of claim 14, wherein each of the M main buffers and the N sub buffers comprises; an output driver that generates a data signal, and an enable controller that selectively enables a corresponding buffer in response to a first control signal.

16. The source driver of claim 15, wherein the M main buffers and the N sub buffers are disabled during the charge sharing.

17. The source driver of claim 14, wherein the M main buffers of the first buffer unit are disposed in parallel to correspond to the M data lines, and the second buffer unit is disposed on a first side of the first buffer unit.

18. The source driver of claim 17, wherein the first switch unit is configured in one connection state such that a Kth gradation voltage is applied to either a corresponding Kth main buffer or one of a sub buffer and a main buffer disposed on the first side of the Kth main buffer, wherein “K” is a positive integer less than or equal to M.

19. The source driver of claim 14, wherein the first and second switch units are configured in a first connection state such that outputs of M buffers belonging to a first group selected from among the M main buffers and the N sub buffers are supplied to the M data lines, and are further configured in a second connection state such that outputs of M buffers belonging to a second group selected from among the M main buffers and the N sub buffers are supplied to the M data lines.

20. The source driver of claim 14, wherein the second switch unit further comprises at least one additional switch that electrically connects the data lines, wherein the at least one additional switch is turned OFF while the data signals are supplied to the data lines and is turned ON while charge sharing is performed.

21. A display device comprising:
a panel that displays an image; and a driving circuit that drives the panel, wherein the driving circuit comprises a source driver that drives data lines of the panel, the source driver comprising:
a buffer unit that receives gradation voltages and generating data signals that drive a panel, the buffer unit comprising a first buffer unit and a second buffer unit, wherein the first buffer unit comprises M main buffers corresponding to M data lines of the panel and the second buffer unit comprises N sub buffers;
a first switch unit that controls a transmission path along which the gradation voltages are applied to the buffer unit; and
a second switch unit comprising switches that control a transmission path along which the data signals are supplied to the data lines, wherein the switches are turned ON when charge sharing is performed,
wherein M is a positive integer, and “N” is a positive integer less than M.

22. A method of operating a display driving circuit for driving a panel, wherein the display driving circuit comprises a first buffer unit with M main buffers corresponding to M data lines and a second buffer unit with N sub buffers, the method comprising:
generating data signals using the first and second buffer units;
controlling a transmission path along which gradation voltages are applied to the first and second buffer units by selectively switching switches in a first switch unit;
controlling a transmission path along which the data signals are supplied to the M data lines by selectively switching switches in the second switch unit; and
electrically connecting the M data lines suing switches in the second switch unit to perform charge sharing,
wherein “M” is a positive integer, and “N’ is a positive integer is less than M.
